(19) United States
(12) Patent Application Publication
(10) Pub. No.: US 2026/0161833 A1
(43) Pub. Date: Jun. 11, 2026

(54) ADVANCED MULTI-FACTOR AUTHENTICATION METHODS FOR HEAD-MOUNTED DISPLAYS UTILIZING BIOMETRIC DATA, VISUAL VERIFICATION, OPTICAL CHARACTER RECOGNITION, AND SECURE NETWORKING PROTOCOLS

(71) Applicant: Adeia Guides Inc., San Jose, CA (US)

(72) Inventors: Ning Xu, Irvine, CA (US); Tao Chen, Palo Alto, CA (US); Reda Harb, Saint Petersburg, FL (US); Dhananjay Lal, Englewood, CO (US)

(21) Appl. No.: 18/975,453

(22) Filed: Dec. 10, 2024

(51) Int. Cl. G06F 21/84; G06F 21/32

(52) U.S. Cl. CPC G06F 21/84; G06F 21/32

(57) ABSTRACT

Methods and systems are provided for multi-factor authentication (MFA) using a head-mounted display (HMD) and a mobile device. A method includes biometric data collection and comparison for secure access. A simplified MFA method provides a region of interest (ROI) (e.g., a bounding box) for user interaction and verification. An MFA method provides an ROI and verification component, enhancing security through visual verification. Another MFA method includes optical character recognition (OCR) to recognize and verify a code displayed on a mobile device. Yet another MFA method includes Neighborhood Aware Networking (NAN) mode and secret sharing to establish a trusted link between the HMD and the mobile device. The methods promote a fully immersive experience by obtaining—without removing an HMD device—authentication information from the mobile device and providing access.

### FIELD OF THE DISCLOSURE

The present disclosure relates to multi-factor authentication (MFA) for head-mounted displays (HMDs).

### SUMMARY

Digital security is crucial in today's world as both businesses and individuals store sensitive information online. Online accounts are relied upon to interact with applications, services, and data. Any breach or misuse of sensitive information can have severe real-world repercussions including financial theft, business disruption and loss of privacy.

Unfortunately, a strong account password alone is no longer considered sufficient to protect personal data and digital accounts (e.g., digital assets) held across network-linked devices. Passwords are created at initial registration to a user profile (e.g., online account) and are referred to as single-factor authentication because account access merely requires entry of the password. If the single-factor authentication (e.g., password) becomes compromised, cybercriminals may be granted access to multiple accounts, especially if the same password is reused. MFA provides an additional layer of security, ensuring that unauthorized users cannot access accounts even if they have obtained the password because an additional security code is required to access the account. Businesses that contain private user information implement MFA to confirm user identities and offer secure access to authorized users.

Modern advancements in immersive display technologies have paved the way for integrating HMDs with complex networking systems which provide users a way to access user profile (e.g., sensitive and private) information. Similar to modern day mobile devices (e.g., mobile phones, laptops, touch pads, or the like) HMDs comprise hardware that may allow the device to access systems linked to personal, financial or medical information. Currently, users face limitations when attempting to authenticate HMDs. In one approach, an authentication technique may include simply entering passwords or using trusted external authentication devices to authenticate an HMD to access a user profile; however, these approaches are slow, and inefficient. For example, typing a password on a virtual or physical keyboard while wearing an HMD may disrupt the immersive experience and may not be feasible due to limited input interfaces. Similarly, using external devices for MFA can interrupt the seamless interaction that HMDs aim to provide, and may lead to user frustration and decreased security if users opt for less secure methods in order to avoid inconvenience. Moreover, existing MFA approaches do not leverage the capabilities already built into some HMDs (e.g., built-in cameras and sensors that may capture biometric data).

In one approach, MFA enhances security by requiring users to provide more than one verification factor to gain access to a resource such as an application or online account. For example, in the case of short message service (SMS)-based verification, the method may include inputting the correct user password followed by a text, from the system to an authenticated mobile device associated with the user profile containing an additional code for the user to input.

In another approach the method may include: 1. Something that the user knows: the user enters their username and password to log in the account, and 2. Something the user has: for example, the user has a mobile phone to receive the SMS verification code or using biometrics to verify the user, e.g., with facial recognition (e.g., Apple FaceID, Google Face Unlock, Samsung Intelligent Scan, Huawei 3D Face Unlock, Microsoft Windows Hello, OnePlus Face Unlock, or the like) or a fingerprint on the user's mobile phone. The second factor may be an application on a mobile device, and the app may present the user a code or require the user to click on one of two options to confirm that they are trying to log in the account. The first factor may be input to a device that is accessed by multiple users, while the second factor in MFA may be an individual device (e.g., mobile phone, touch pad, or the like) with a unique number or subscriber identity module (SIM), or on the individual device (e.g., mobile phone, touch pad, or the like) with an installed application. The second factor or unique device may be associated with the account (e.g., unique user profile) of the first factor, and the user has to have nearly instant access to the device.

HMDs are not immune to cybersecurity threats. As HMDs increasingly integrate with cloud-based services, Internet of Things (IoT) devices, online accounts, as well as store sensitive data locally, they become potential targets for malicious attacks (e.g., hacking, cyber-attacks, or the like) aimed at accessing sensitive data (e.g., financial information, private communications, user data, or the like). Accordingly, there exists a need in the art for improved security methods and systems for HMDs.

To help address the limitations and problems of these and other approaches, in some embodiments, various designs of MFA systems and methods for HMDs are provided. In some embodiments, the MFA system accesses functionality, components, and/or devices of the HMD (e.g., inward-facing cameras) to capture biometric data (e.g., 3D shape of the user's eyes, retinal scanning, IR facial data scans, or the like) already associated with the user profile (e.g., of the HMD). In some embodiments, verification of biometric data may be used, at least in part, for MFA to authenticate the HMD and subsequently allow access to a user profile on the HMD. In some embodiments, biometric data collected by devices in the HMD (e.g., inward-facing cameras) may be used to unlock features (e.g., mobile device as an HMD controller) on a mobile device (e.g., mobile phone, touchpad, or the like). In some embodiments, the biometric data collected by the HMD may be transmitted to the mobile device (e.g., authenticated mobile device) to perform biometric data verification. The transmitted biometric data may be compared, by a secure application on the mobile device, to locally saved biometric data (e.g., facial data) on said mobile device.

The term “biometric data” should be understood to include any data derived from measurements of physical or behavioral characteristics of an individual and may include data obtained from fingerprints, facial features, iris patterns, voice patterns, or other physiological or behavioral characteristics, and/or any processed representations thereof. Thus, it should be understood that the biometric data may vary depending on the method of data collection, processing algorithms, or storage format. Similarly, the term “biometric identifier” includes any unique attribute or feature used to distinguish or verify the identity of an individual, including but not limited to fingerprint templates, facial recognition vectors, iris codes, voice prints, or any mathematical representation derived from biometric data. Thus, the terms “biometric data” or “biometric identifier” may include raw data captured during the initial data acquisition and any processed or transformed data during subsequent processing stages. Depending on the stage of data collection, processing, or authentication, the terms “biometric data” and “biometric identifier” may be used to describe data captured, processed, stored, or transmitted by a device.

In one example, biometric data may include data collected by a detector (e.g., infrared detector) that may be used to construct a 3D facial depth map. The biometric data (e.g., 3D facial depth map) may be locally stored on a device and mapped to a specific user profile as a unique identifier.

In some embodiments, an HMD may be a video-see-through (VST) HMD and/or an optical-see-through (OST) HMD. VST HMDs allow for indirect vision of an environment while OST HMDs allow for direct vision of an environment. Both types of HMDs may be capable of different reality settings (e.g., augmented reality (AR), virtual reality (VR), mixed reality (MR), or the like) depending on the mechanical and optical components of said HMD.

A general aspect includes a method for authenticating an HMD. The method comprises receiving a request to access a user profile on an HMD (e.g., applications associated with the device, some examples may include but are not limited to banking systems, HMD user profiles, or any suitable application containing sensitive information), initiating an authentication process in response to the request, where the authentication process includes, at least in part, a biometric scan. The method further comprises collecting, by the HMD, biometric data with the biometric scan, generating a first biometric signature based at least in part on the biometric data and transmitting the first biometric signature to a mobile device associated with the user profile. The method may cause the mobile device, to compare the first biometric signature to a second biometric signature stored on the mobile device, where the second biometric signature is associated with the user profile. The method may further cause the mobile device, to determine a similarity score, based at least in part on the comparing the first biometric signature to the second biometric signature and completing the authentication of the HMD based at least in part on the similarity score.

In some approaches, the biometric signature may include a plurality or biometric signatures. For example, a biometric signature may include a first and second biometric signature where the first biometric signature comprises biometric data (e.g., facial data on a first location of a face), and the second biometric signature comprises biometric data (e.g., facial data on a second location of a face). In some embodiments, the first and second biometric signature may contain overlapping data.

In some embodiments, the first and second biometric signature may comprise biometric data from different biometric features. For example, a biometric signature may comprise a first biometric signature and a second biometric signature where the first may comprise biometric data because of a facial scan and the second may comprise biometric data as a result of an eye scan. In one approach, the collection of biometric data may result in generating a data point cloud and/or vector information. In one embodiment, while determining a similarity score the feature vectors (e.g., of the eye) can be compared to the corresponding feature vectors (e.g., of the eye region) within a full facial signature to determine the degree of similarity. Weights may be assigned to eye-specific features to evaluate their influence on the overall uniqueness of the facial signature. For instance, an iris pattern might be assigned a higher weight due to its distinctiveness compared to general skin texture.

In another approach, machine learning (ML) models may be utilized to achieve this comparison. These models can be trained to predict the likelihood of a match between the eye biometric data and the full facial biometric data. For example, a support vector machine (SVM) or a neural network may be implemented to classify whether the eye-specific biometric data corresponds to the broader facial biometric data.

In some embodiments the method further comprises, subsequent to determining the similarity score, determining that the similarity score is above a threshold, and transmitting a positive verification signal to the HMD causing the HMD to be authenticated for accessing the user profile.

In some embodiments, the method further comprises scanning an inwardly-facing area inside the HMD using an imaging system of the HMD to capture 3D eye data, and generating the first signature based at least in part on the captured 3D eye data.

In some embodiments, the method further comprises scanning an inwardly-facing area inside the HMD using an imaging system of the HMD to capture at least a portion of facial data, and generating the first signature based at least in part on the captured portion of the facial data.

In some embodiments, the method further comprises prior to transmitting the positive verification signals to the HMD, generating for display on the HMD, instructions to perform an action, causing, at the mobile device, execution of the action, and causing, at the mobile device, validation of the action. In some embodiments, validation of the biometric signature may be performed on a remote server.

Another general aspect includes a method performed by a HMD, for simplified MFA with a mobile device. The method comprising receiving by the HMD a login authentication request associated with a user profile, transmitting an MFA request from the HMD to a server, which causes the server to transmit a verification component to the mobile device, where the mobile device is associated with the user profile, and causes the mobile device to display the verification component. The method may further comprise generating, on a display of the HMD, a region of interest (ROI), e.g., a virtual frame, a bounding object, a bounding box, or the like. Application of the ROI (and the like) is detailed herein. The ROI is, for example, a frame used in VR and AR to define the boundaries of a virtual object or scene within a viewable area of the VR/AR device. In the context of graphical user interfaces (GUIs) for VR devices and other computer vision applications, a bounding box is commonly understood as a (e.g., rectangular) frame used to define the position and size of an object within an image or video frame. The virtual object is a fundamental tool in tasks such as object detection, image segmentation, and image annotation. Also, the ROI is any specific area within an image or video frame selected for further analysis or processing. Bounding boxes are a specific type of ROI. Further, for example, the vision frame is at least one of an annotation, object localization, image segmentation, scene understanding, or the like. In addition, for example, the ROI is at least one of a tight bounding box, which closely fits the object without including much background; a loose bounding box, which includes some background around the object; an axis-aligned bounding box (AABB), which is aligned with the coordinate axes; a rotated bounding box, which can be rotated to better fit the orientation of the object; or the like. Moreover, for example, polygon annotation is a method that uses polygons to outline the exact shape of an object.

Also, for example, the method comprises causing the identification of the verification component. Further, for example, the ROI is viewable through the VR/AR device to alight with an object or image within the viewable area of the device. In addition, for example, the method comprises causing the user profile to be authenticated for use on the HMD. In some embodiments, the method may comprise features on the HMD to automatically identify the verification components.

In some embodiments, the display of the verification component comprises displaying a quick response (QR) code. In some embodiments, the display of the verification component comprises displaying a text string or alphanumerical content.

In some embodiments, causing the user profile to be authenticated for use on the HMD further comprises communicatively coupling the mobile device to HMD to allow the mobile device to control, at least portions, of the HMD.

In some embodiments, causing the identification component by the ROI further comprises scanning by an outward-facing camera on the HMD the verification component on the mobile device, causing the ROI and the verification component to align, identifying a code correlated to the scanned verification component, and comparing the code to an authentication code.

Related devices, systems, non-transitory computer-readable media, and the like are provided for enhancing security and convenience, e.g., for HMD users with trusted mobile device.

The present invention is not limited to the combination of the elements as listed herein and may be assembled in any combination of the elements as described herein. These and other capabilities of the disclosed subject matter will be more fully understood after a review of the following figures, detailed description, and claims.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration these drawings are not necessarily made to scale.

The embodiments herein may be better understood by referring to the following description in conjunction with the accompanying drawings in which like reference numerals indicate identically or functionally similar elements, of which:

FIG. 1 depicts a rendering of an example HMD device communicatively coupled to a mobile device, in accordance with some embodiments of this disclosure;

FIG. 2 shows a flow diagram of an example process for MFA, in accordance with some embodiments of this disclosure;

FIG. 3 shows a flow diagram of an example process for MFA, in accordance with some embodiments of this disclosure;

FIG. 4A shows a viewing perspective of an HMD in which a user is holding a mobile device displaying a field for entry of a verification code, and the HMD superimposes a bounding box over an area of the viewing perspective corresponding to the verification code, in accordance with some embodiments of the disclosure;

FIG. 4B shows another viewing perspective of an HMD in which a user is holding a mobile device displaying a QR code, and the HMD superimposes a bounding box over an area of the another viewing perspective corresponding to the QR code, in accordance with some embodiments of the disclosure;

FIG. 5 shows a flowchart of an example process for biometric verification with dynamic, context-sensitive actions, in accordance with some embodiments of the disclosure;

FIG. 6 depicts an illustrative user equipment device, in accordance with some embodiments of this disclosure;

FIG. 7 depicts an illustrative user equipment system, in accordance with some embodiments of this disclosure;

FIG. 8 shows a flowchart of an example process for simplified MFA for users wearing an HMD, in accordance with some embodiments of the disclosure;

FIG. 9A-9B shows a flowchart of an example process for authenticating an untrusted HMD with a trusted device, in accordance with some embodiments of the disclosure;

FIG. 10 shows a flowchart of an MFA process using an HMD, including receiving an MFA request, collecting and transmitting biometric data, and authorizing access, in accordance with some embodiments of the disclosure;

FIG. 11 shows a flowchart of a simplified MFA process using an HMD and mobile device, including receiving a log in request, transmitting an MFA request, and authenticating based on a recognized bounding object, in accordance with some embodiments of the disclosure;

FIG. 12 shows a flowchart of an MFA process involving a bounding box and verification component, including receiving a log in request, generating a bounding box, and verifying a recognized component, in accordance with some embodiments of the disclosure;

FIG. 13 shows a flowchart of an MFA process using optical character reader (OCR) on an HMD, including logging in, transmitting an MFA request, recognizing a verification code, and granting access, in accordance with some embodiments of the disclosure; and

FIG. 14 shows a flowchart of an MFA process using Neighborhood Aware Networking (NAN) mode and secret sharing, including opening an authentication application, entering NAN mode, sharing a secret, and establishing a trusted link, in accordance with some embodiments of the disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting embodiments and that the scope of the present invention is defined solely by the claims.

### DETAILED DESCRIPTION

Methods and systems are provided to eliminate the need for users to remove an HMD during authentication. That is, secure access is provided without disrupting full immersion.

Embodiments herein provide for methods to authenticate an HMD through MFA. Advances in wearable computing and display technologies have enabled the creation of HMD systems that present digitally generated images or portions thereof to a user in a manner that they appear real or seamlessly integrated with the user's environment (e.g., immersive environments). Some examples of these immersive environments are, extended reality (XR), which includes VR, AR, and MR scenarios. In a VR scenario, the HMD presents digital or virtual image information without transparency to the real-world visual input, fully immersing the user in a simulated environment. In contrast, an AR scenario involves overlaying digital or virtual image information onto the user's view of the actual world, augmenting their perception with additional data or virtual objects. MR blends elements of both VR and AR, allowing real and virtual objects to coexist and interact in real time.

These immersive experiences can be facilitated through devices operating in OST and/or VST modes. OST devices utilize transparent display elements or optical combiners to overlay digital content onto the user's direct view of the real world, enabling simultaneous perception of both real and virtual environments. VST devices, on the other hand, capture the real-world environment using outward-facing cameras and display it on screens inside the HMD, onto which digital content can be superimposed. This method provides the ability to manipulate the visual input before it reaches the user's eyes, allowing for more extensive augmentation or alteration of the real-world view.

MFA may be understood as a security process that requires users to provide multiple (e.g., at least two) forms of verification before granting access to a system, device, or account. In one embodiment, a first step of an MFA process may be to input a code (e.g., password and/or personal identification number (PIN)) when attempting to access a user profile on a device. Upon successful entry of said code, the system may cause the device to initiate a second step of an MFA, and this may continue on to any suitable number or process steps.

Due to recent advances in computer vision systems, many HMD devices may comprise complex imaging capabilities. Some examples may include inward-facing cameras for eye tracking and facial recognition, outward-facing cameras for environmental mapping and gesture recognition, depth sensors for three-dimensional spatial awareness, and infrared sensors for low-light imaging. The imaging systems already on most HMDs may be used to collect biometric data of a user in order to provide an additional step (e.g., added security) for HMD MFA use.

In one embodiment, the first authentication factor may be input on a device that is accessed by multiple users, such as a shared computer or public terminal. The second factor typically involves an individual or personal device, such as a mobile phone with a unique number or SIM card, or a mobile phone with an installed authentication application. This second factor or unique device is associated with the account of the first factor, and the user accesses this personal device to complete the authentication process.

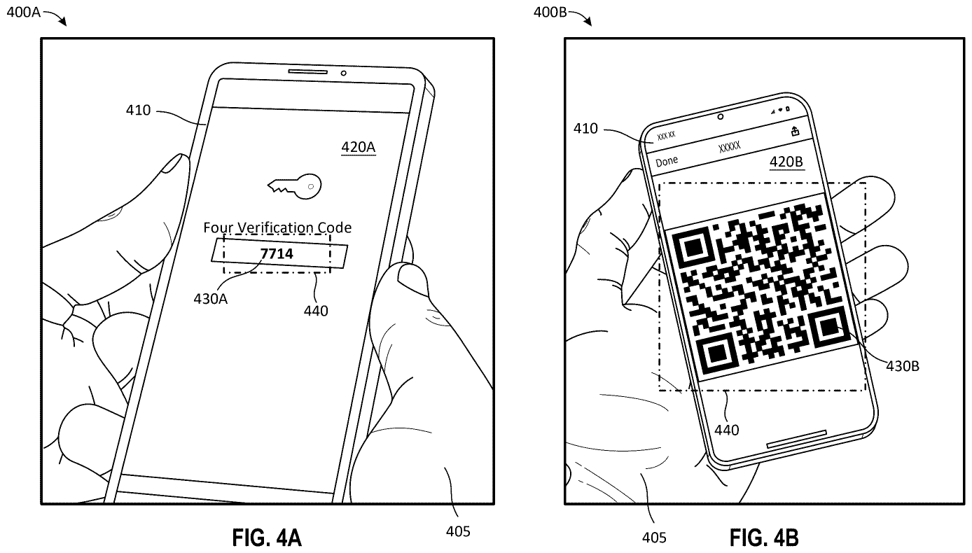

Once the system confirms the password in an MFA process, it proceeds to the next step. For example, the system might generate a code on a hardware token or send a code via SMS to the user's mobile phone. There are various ways to implement MFA; for instance, a third-party application (e.g., an authenticator app) may verify the user's identity. In such cases, the user enters a one-time passcode or PIN into the authenticator, which then confirms the user's identity to the system. FIG. 3 illustrates an example of the MFA steps. In some embodiments, the MFA may include an additional step including biometric verification.

One challenge with MFA is user resistance due to the added complexity and time required for authentication, which can potentially frustrate users. According to some reports, a notable percentage of small and medium-sized businesses (SMBs) view MFA as too inconvenient to use. This issue is exacerbated when the user is wearing an HMD; removing the headset to handle MFA tasks—such as receiving an SMS code and inputting it into the HMD—can be cumbersome and disruptive. For users who currently rely on single-factor authentication (1FA), incorporating automated authentication methods that do not require manual operation can enhance security without adversely affecting the user experience.

Practical scenarios exist where a second device, such as a personal mobile phone, is otherwise required—especially when the HMD is not a personal device and does not store the user's biometric identifiers for authorization and authentication. Additionally, there are use cases where the user browses and purchases merchandise through various websites that do not have pre-stored payment methods, requiring the user to authorize payment through a mobile device.

This process is conveniently facilitated through mobile payment platforms, allowing for secure and efficient transactions.

When users are required to remove their HMDs to interact with their mobile devices for MFA—such as unlocking the device via facial recognition or entering a passcode—a challenge arises. Even when the mobile device can be accessed via fingerprint recognition, the user still otherwise needs to perform an action on the mobile device to complete the authentication. This interruption not only diminishes the user experience but also introduces potential security vulnerabilities, as users temporarily disengage from their HMD environment to complete the authentication process.

In some embodiments, a method comprises generating a dynamic action instruction, displaying the dynamic action instruction, receiving input, determining if the input matches the dynamic action instruction, and authorizing access to the HMD or functions of the HMD based on the determination and an authorization signal. For example, the dynamic action instruction comprises tapping a virtual icon with a mobile device, with the input being a visual confirmation by the HMD. The determination is made when the virtual icon is tapped with the mobile device. Also, for example, the dynamic action instruction comprises performing a gesture in a virtual space visible to the HMD, with the input being a visual confirmation by the HMD. The determination is made when the gesture is performed in the virtual space. Further, for example, the dynamic action instruction comprises performing a spatial gesture with a mobile device, with the input being a confirmation from the mobile device. The determination is made when the mobile device confirms the spatial gesture was performed. In addition, for example, the dynamic action instruction is generated for display on, e.g., an HMD, a mobile device, or the like.

Moreover, for example, the dynamic action instruction is visible from a perspective of a user via, e.g., OST, VST, or the like.

As used herein, the term “input” is intended to include a broad variety of input sources and input information including those described herein. For example, motion controllers are handheld devices that track the user's hand movements and gestures. Also, for example, head tracking comprises sensors in the HMD that track the orientation and position of the user's head. Further, for example, eye tracking technology monitors where the user is looking to enhance interaction and realism. In addition, for example, hand tracking uses cameras and sensors to detect and interpret hand movements without the need for controllers. Moreover, for example, voice commands utilize microphones and voice recognition software to allow users to control the system using spoken commands. Furthermore, for example, haptic feedback devices provide tactile feedback to simulate touch and interaction with virtual objects. Additionally, for example, spatial tracking systems track the user's position in a physical space to reflect movement in the virtual environment. Still further, for example, gesture recognition employs cameras and sensors to recognize specific gestures made by the user. Even further, for example, touchpads and buttons are integrated into controllers or the HMD itself for additional input options. Yet further, for example, mobile device integration comprises using smartphones or tablets as input devices, often through tapping or spatial gestures.

To address these challenges, embodiments herein propose methods that allow HMD users to authenticate seamlessly without removing their devices, thereby providing enhanced security and convenience. These methods leverage the imaging capabilities of HMDs and trusted mobile devices to implement MFA processes that are integrated into the user's immersive experience, minimizing disruptions and maintaining high levels of security.

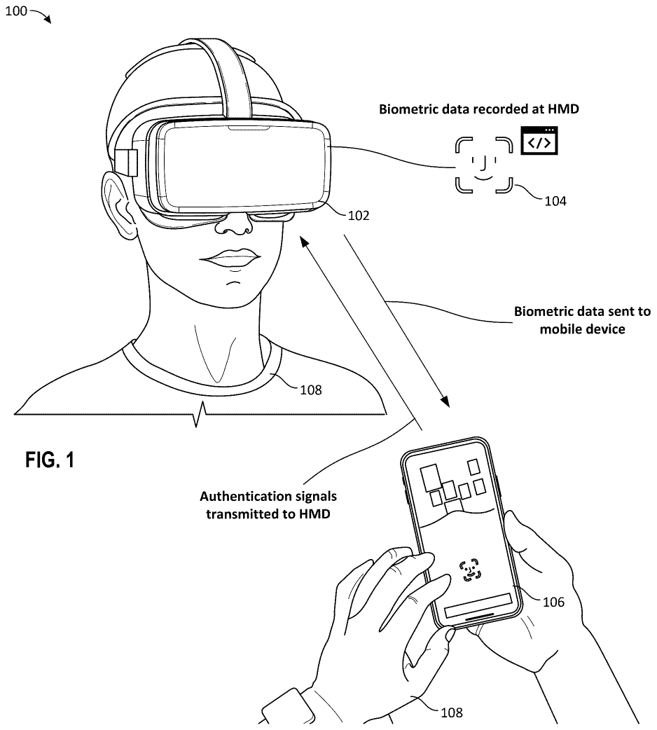

FIG. 1 illustrates a two-part rendering, for an MFA process 100 on an HMD 102, the first part (e.g., the top render) is of a user 108 wearing a HMD 102 (e.g., XR OST), and the second part (e.g., the bottom drawing), is a point-of-view of the user 108 seeing through the HMD 102 to use a mobile device 106 (e.g., mobile phone) to complete, at least in part, the MFA process 100 on the HMD. For example, the user 108 may initiate logging into a user profile associated to an operating system (OS) on the HMD. In some embodiments, the user 108 may be prompted to input a first part of an MFA (e.g., enter in a user profile ID (e.g., user account ID) and password/PIN) and may upon successful input automatically trigger initiation of the second step of the MFA process 100 (e.g., biometric verification).

In some embodiments, the second step of the MFA process 100 includes biometric verification. The HMD 102 may use inward facing cameras, to collect facial data. The collection of the biometric data by biometric scans may be compiled and sent to an authenticated mobile device (e.g., mobile phone) where the mobile device is already associated with the user profile. An application on the mobile device 106 may compare the compiled biometric data recorded at the HMD 104 to biometric data recorded at the mobile device 106. In some embodiments, a similarity score is calculated by comparing the compiled biometric data recorded at the HMD 104 to biometric data recorded at the mobile device 106. The similarity score may be used to identify successful verification or unsuccessful verification of the biometric data. In some embodiments, upon successful verification the mobile device 106 may send signals to the HMD which causes the HMD to be authenticated for use of a user profile (e.g., user account). In some embodiments, upon unsuccessful verification the mobile device 106 may send signals to the HMD which causes the HMD to block the user profile to be used on the HMD.

In one embodiment, biometric scans may include collecting facial data. In some embodiments, collecting facial data involves utilizing a combination of specialized sensors (e.g., HMD hardware) and algorithms (e.g., HMD software) to generate a three-dimensional representation of a user's face. In some embodiments, the HMD may emit a structured light pattern onto the user's face using an infrared dot projector. In some embodiments, the pattern consists of numerous infrared light points that, when projected onto the facial contours, create a unique distortion based on the individual's facial geometry. An infrared camera (e.g., inward-facing camera) may be used to capture the distorted pattern, and the device's processing unit may be utilized to record and analyze the distortions to construct a detailed depth map of a face.

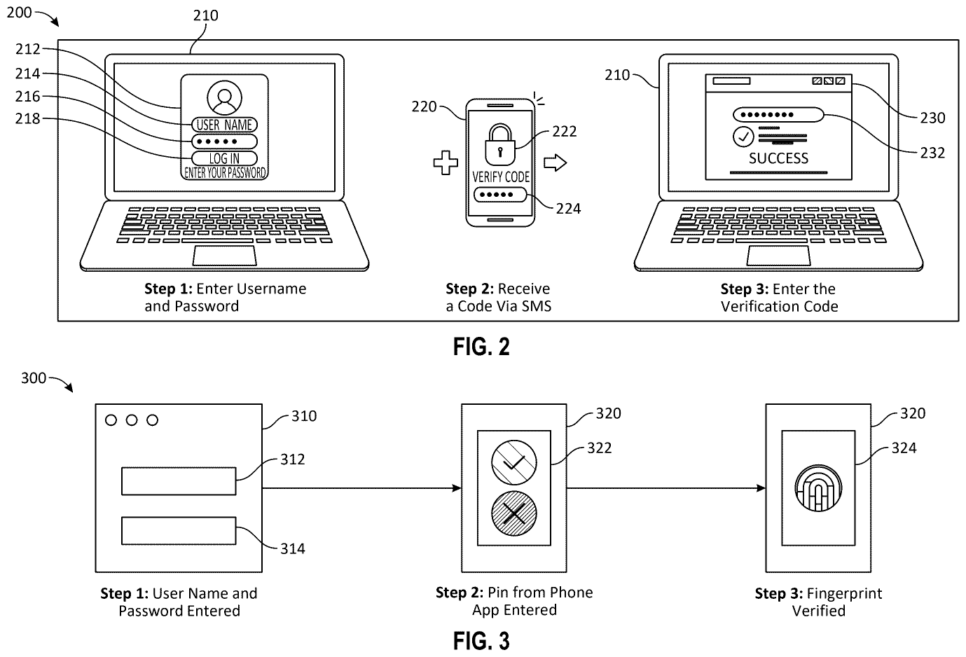

FIG. 2 schematically illustrates an embodiment of an MFA method 200, in accordance with some embodiments of the present disclosure. The MFA method 200 may include two mobile devices (e.g., a laptop 210 not authenticated and an authenticated mobile phone 220). In some embodiments, a user may initiate a request to access a user profile 212 on a mobile device (e.g., laptop 210). The mobile device (e.g., laptop 210) may not be authenticated and therefore may initiate the MFA method 200. In some embodiments, the MFA method 200 is a two-step method comprising, at least, a first step and a second step. For example, the first step may include entering a username 214 and password 216 to access a user account of a system on a mobile device (e.g., laptop 210). Upon successful input of the username 214 and password 216 (e.g., imputing respective codes and causing an action to press “Log In” 218) combination the first step of the MFA may be identified as complete and proceed to the second step.

In some embodiments, the second step of the MFA method 200 may include sending an authentication code 224 to a secondary mobile device (e.g., authenticated mobile phone 220) for input on the first mobile device (e.g., laptop 210). In some embodiments, the authentication code 224 may be sent to the via SMS. In some embodiments, the SMS may comprise a link to a URL 222 comprising the authentication code 224.

Upon receiving the authentication code 224 on the second mobile device (e.g., authenticated mobile phone 220) the first mobile device (e.g., laptop 210) may show an input screen 230 and a location 232 to input the authentication code 224. Once the authentication code 224 is input and successfully identified by the system, the first mobile device (e.g., laptop 210) is authenticated, and the user profile may be accessed on the first mobile device (e.g., laptop 210).

FIG. 3 schematically illustrates an embodiment of an MFA method 300, in accordance with some embodiments of the present disclosure. The MFA method 300 may have similar features to the MFA method 200 described above, and therefore the description of similar features may be omitted for brevity. In some embodiments, the MFA method 300 is a three step MFA comprising; a first step, input of a user profile ID 312 and password 314 on a first mobile device 310 (e.g., to be authenticated), a second step, pin from a second mobile device 320 (e.g., authenticated mobile phone) and a third step, biometric verification 324 (e.g., fingerprint scanning) done on the second mobile device 320.

In some embodiments, the first and second steps of the MFA method 300 are similar to the MFA method 200 described above. In some embodiments, an authentication code is sent to an application on the second mobile device (e.g., e.g., authenticated mobile phone). In some embodiments, the authentication code may be an action (e.g., to press a green check 322). In some embodiments, the authentication code may be a text string on an application on a second mobile device (e.g., authenticated mobile phone).

Upon successful completion of the first and second steps of the MFA method 300, the MFA may automatically initiate a third step (e.g., biometric verification). In some embodiments, software correlated to the system on the authenticated mobile device may initiate biometric scanning. In some embodiments, biometric scanning 324 includes fingerprint scanning, as illustrated in the FIG. 3. In some embodiments, the authenticated device collects biometric data (e.g., fingerprint) and compares it to biometric data already stored on the authenticated device.

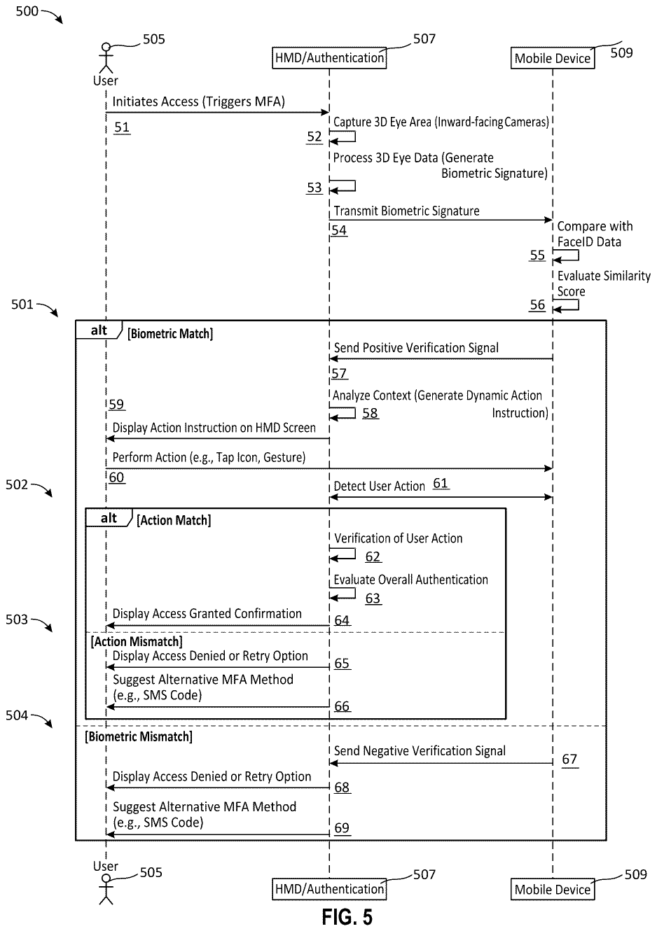

FIG. 4A schematically illustrates the point of view (POV) of a user 405 wearing an HMD during the MFA process 400A. For example, the user 405 may initiate the MFA process 400A on the HMD to designate it as a trusted device for a specific user profile. Initiating the MFA process 400A (e.g., logging into a particular user profile on the HMD) may cause the system (e.g., HMD and/or external server) to send a code 430A (e.g., SMS and/or as a text string within an application) to a mobile device 410 (e.g., a trusted device associated with the user profile). The HMD may then generate a frame 440 (e.g., a bounding box, code scanning frame, code detection frame, or the like) that is configured to identify (e.g., automatically or manually) the code 430A (e.g., SMS and/or as a text string within an application) when it appears within (e.g., partially, or wholly) the perimeters of said frame 440 (e.g., a bounding box, code scanning frame, code detection frame, or the like).

In some embodiments, the HMD may be a video-see-through (VST) display. The HMD may generate virtual images of the surroundings (e.g., overlapping a virtual environment over the real-world surrounding environment) on a display, providing the user 405 with a real-time video feed of their environment augmented with virtual elements (e.g., frame 440). During the MFA process 400A, the HMD can overlay an ROI (e.g., frame 440) or indicator (e.g., frame 440 or other suitable identifier) onto the user's view to assist in aligning the code 430A (e.g., SMS and/or as a text string within an application) displayed on the mobile device 410. In some embodiments, the HMD's external cameras may capture the environment, and the system processes the video feed to detect and read the code 430A (e.g., SMS and/or as a text string within an application) when it enters the ROI (e.g., frame 440). This process may allow the user 405 to authenticate the HMD without requiring the user 405 to remove the headset.

In some embodiments, the HMD may be an optical-see-through (OST) display. An OST HMD may allow a user 405 to view the real-world environment directly through transparent or semi-transparent optical elements (e.g., transparent display, liquid crystal display (LCD) or other suitable see-through displays) while overlaying virtual images (e.g., frame 440) onto the field of view. During the MFA process, the OST HMD may generate an ROI (e.g., frame 440) or indicator (e.g., frame 440 or other suitable identifier) on the transparent display (e.g., into the user's line of sight) to allow the user to align the code 430A (e.g., SMS and/or as a text string within an application) displayed on the mobile device 410 with the frame 440. The user 405 may view the mobile device and the overlaid ROI simultaneously, enabling them to position the code 430A within the frame 440 (e.g., detection area).

In some embodiments, the HMD may utilize integrated sensors, cameras, and image processing software to detect and read the code 430A when it enters the ROI (e.g., frame 440). In some embodiments, the HMD may utilize integrated sensors, cameras and image processing software to automatically detect and read the code 430A. For example, the HMD may utilize integrated sensors, cameras and image processing software to automatically detect and read the code 430A without use of an ROI or the like.

In some embodiments, the MFA process 400A may be initiated when biometric verification fails or is unavailable. For example, initiating MFA on the HMD may cause the HMD to automatically initiate scanning for biometric data. Failure on the HMD to collect biometric data may automatically cause the HMD to send a code 430A (e.g., SMS and/or as a text string within an application) to a trusted mobile device 410 associated with a user profile.

Although FIG. 4A shows a 4-digit numerical code 430A (e.g., “7714” as illustrated), the code 430A may comprise any suitable characters, numbers, and/or symbols. In some embodiments, the code 430A may comprise any number of characters/numbers (e.g., 2, 6, 10, or the like). In some embodiments, the code 430A may be automatically detected by real-time image processing software communicatively coupled to the camera system of the HMD. In some embodiments, the code 430A may be entered manually on the HMD to complete the authentication process. In some embodiments, the code 430A may be entered manually on a remote device (e.g., application on a mobile device 410). In some embodiments, the code 430A may be entered manually on the HMD (e.g., touch screen and/or virtual keyboard).

In some embodiments, initiating the MFA process 400A on the HMD automatically generates a code 430A on an application 420A on a mobile device 410 (e.g., trusted device). The application 420A may correspond to the HMD or be an authentication application associated with the system linked to the HMD (e.g., external server). The authentication application may generate verification codes that are time-sensitive and/or unique to each authentication session (e.g., each initiated MFA process 400A).

In some embodiments, the mobile device 410 will detect the HMD using the front facing camera(s) to detect an HMD and automatically display the code 430. For example, the system may unlock the screen on the mobile device 410 to show the code 430 with a fingerprint scan or a swipe pattern shown on the HMD display.

FIG. 4B schematically illustrates the point of view (POV) of a user 405B wearing an HMD during the MFA process 400B. In some embodiments, the MFA process 400B corresponds to (e.g., is similar to or the same as) the MFA process 400A but comprising different code 430B (e.g., QR code).

In some embodiments, MFA process 400B comprises sending to a mobile device 410, a message (e.g., SMS) containing a QR code (e.g., code 430B). In some embodiments, a URL is sent to the mobile device 410 the URL containing a link to a QR code (e.g., code 430B). In some embodiments, by initiating the MFA process 400B a QR code (e.g., code 430B) is automatically generated on an application 420B of a mobile device 410 (e.g., trusted device). In some embodiments, the HMD's image recognition software may comprise QR code recognition algorithms to read and decode identified QR codes (e.g., code 430B).

In some embodiments, the HMD decodes the QR code (e.g., code 430B). For example, the system (e.g., server, database or the like) may generate a unique QR code (e.g., code 430B) containing encrypted authentication data or a one-time password (OTP). The QR code (e.g., code 430B) may be displayed on a screen of a mobile device 410 or an authentication terminal (e.g., application 420B). The HMD may be used to scan for the QR code (e.g., code 430B) using the ROI (e.g., frame 440). Upon scanning, the device decodes the QR code to extract the embedded authentication information. The extracted authentication data may then be transmitted to the system (e.g., server, database or the like) for verification, either directly through a secure network connection or via an authentication application installed on the HMD. The system validates the authentication data against its security protocols and, if verified, grants access or unlocks the device or system in question.

In another embodiment, the user positions the verification code on the mobile phone within a bounding box displayed on the HMD screen before the HMD uses its front camera to capture the code, processes the captured image using OCR to extract the code, and sends the extracted code or authentication data to the authentication server for verification. If the code is correct, the authentication server grants access to the user. It is noted, for example, extracting and sending a simple code versus a QR code varies as appropriate. Also, for example, compression of a QR code involves relatively greater resource usage. Whereas, with a relatively simplistic format such as a 6-digit code, extracting and sending the 6-digit code in its visual representation is relatively straightforward, either has a converted and/or interpreted code or even as a portion of an image (e.g., within a bounding box). Further, for example, if a 6-digit code is used, the system may be configured to detect that it is a 6-digit code, convert it (e.g., locally), and send it for verification. In addition, for example, the system is configured to detect and/or convert and/or interpret a QR code, and, after extraction of the code embedded in the QR code, send the extracted information verification.

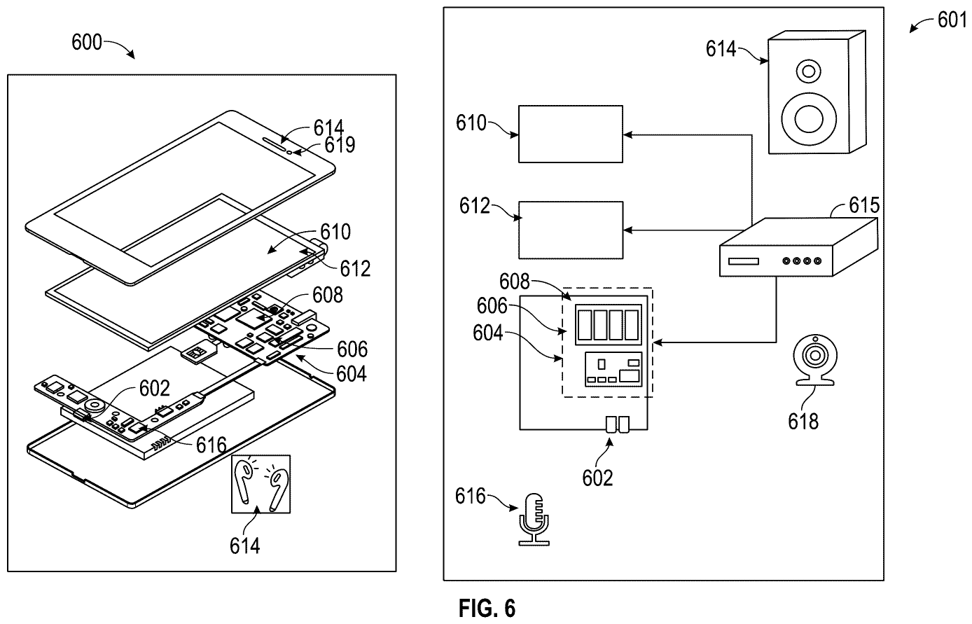

FIG. 5 illustrates a method 500 using a process flowchart for MFA. The method 500 may include a user 505 associated with a user profile, an HMD 507, and a mobile device 509 (e.g., trusted mobile phone). In one embodiment, the method 500 is performed by an HMD 507, the process begins, at step 51, with the user initiating the login process by sending an authentication request for a service. At step 52 the HMD 507 may initiate biometric scan(s) (e.g., capturing 3D eye area). In some embodiments, biometric scans are collected by inward-facing cameras on the HMD 507 and may be triggered automatically by the initiated authentication request.

At step 53, the data collected from the biometric scans is processed (e.g., compiled) into a biometric signature. In some embodiments, the biometric signature may comprise data from a single biometric scan or a plurality of biometric scans.

At step 54, the biometric signature is transmitted by the HMD to the mobile device 509 (e.g., trusted mobile phone).

At step 55, the HMD 507 may cause the mobile device 509 to compare the transmitted biometric signature with a local biometric signature (e.g., FaceID, locally saved biometric scans, or the like). In some embodiments, the transmitted biometric signature may be understood as a first biometric signature and the biometric signature stored locally on the mobile device may be understood as the second biometric signature.

At step 56 the system may cause the mobile device 509 to determine a similarity score, based at least in part on the comparing the first biometric signature to the second biometric signature.

In some embodiments, the method includes a biometric match determination 501. At step 57, when a similarity score is determined to be above an appropriate threshold (e.g., 98% correlation) positive signals may be transmitted by the mobile device 509 to the HMD 507 and cause the HMD 507 to authenticate (e.g., for use by the user profile).

In some embodiments, the method includes an additional multi-factor authentication (e.g., action match identification 502). At step 58, prior to the HMD receiving positive verification signals, the system may trigger an event to cause an additional verification step.

At step 58, the HMD 507 may internally generate dynamic action instructions. At step 59, the HMD 507 may generate for display action instructions (e.g., tap a button, motion hands, tap icon, gesture, or the like). For example, the HMD 507 may generate for display instructions to interact with a code on a mobile device similar to or the same as previously described in FIGS. 2-4B.

At step 60, the user 505 may perform the required action (e.g., tap a button, motion hands, tap icon, gesture, or the like) on the mobile device 509. At step 61, the successful completion of the action may result in the authentication of the HMD 507 or may cause additional verification of the action 502. In some embodiments, at step 62, the HMD 507 may verify the action received. At step 63, the HMD 507 may evaluate an overall authentication, and cause the HMD 507 to display access granted (e.g., confirmation identification) at step 64.

In some embodiments, the method includes evaluating that an action is a mismatch. For example, subsequent to an action being detected by the HMD 507, the action may be determined to be incompatible, e.g., with the action instructions. At step 65, when the HMD determines that the action is a mismatch, the HMD 507 may generate for display messages (e.g., access denied, retry options, or any other appropriate message). In some embodiments, at step 66, the HMD may generate for display a suggestion of an alternative MFA method (e.g., methods described in FIGS. 2-4B).

In some embodiments, the method may comprise determining a biometric mismatch 504. Subsequent to step 56, a similarity score may be determined to be not above an appropriate threshold and may be interpreted as a mismatch. At step 67, the system may cause the mobile device 509 to send negative verification signals to the HMD 507. At step 68, the HMD 507 may generate for display a access denied message and/or a selectable retry option. In some embodiments, at step 69, the HMD may generate for display a suggestion of an alternative MFA method (e.g., methods described in FIGS. 2-4B).

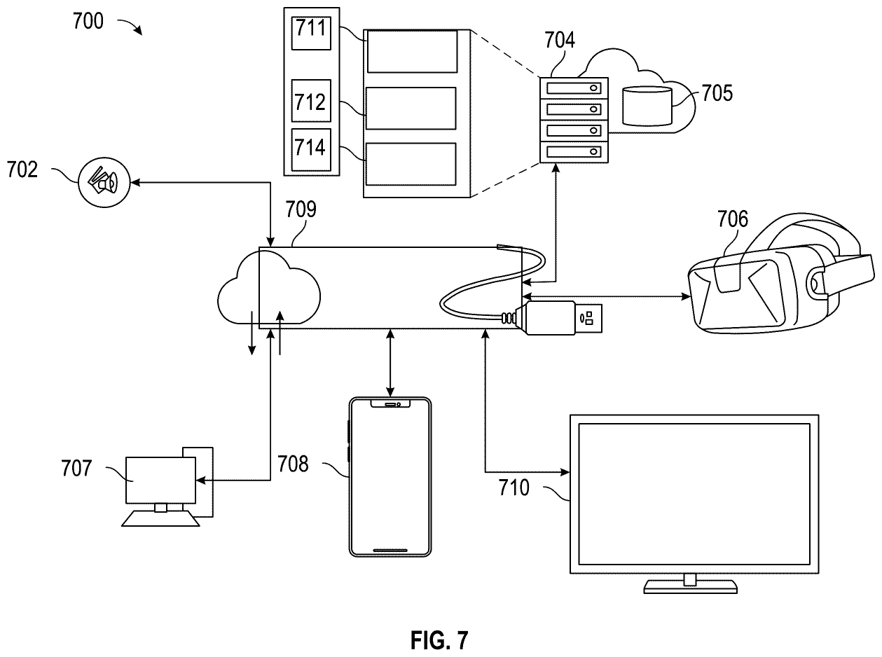

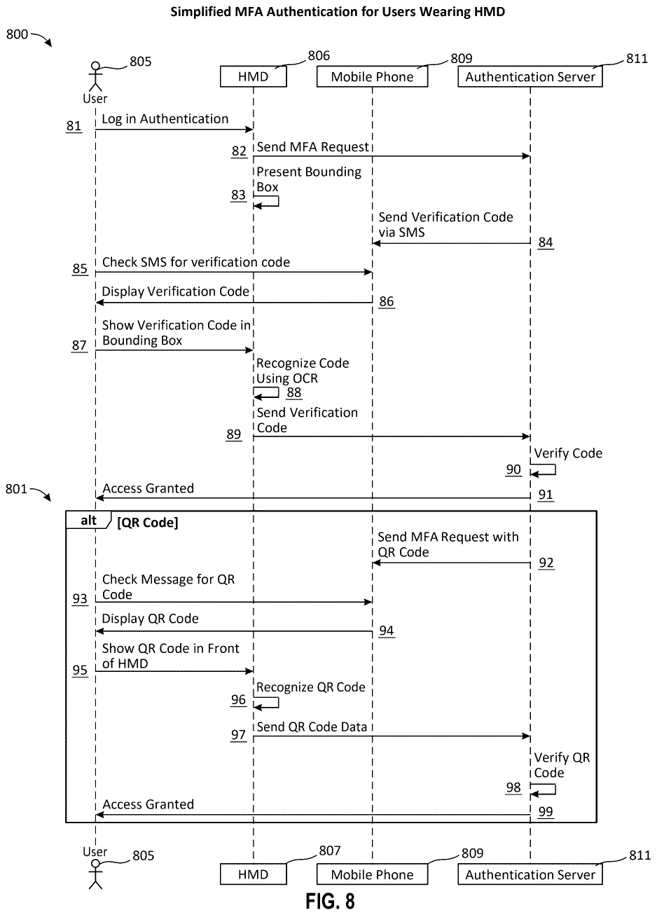

FIGS. 6-7 describe illustrative devices, systems, servers, and related hardware for generating for display AR and VR images for MFA (e.g., ROI), in accordance with some embodiments of the present disclosure. FIG. 6 shows generalized embodiments of illustrative user equipment 600 and 601, which may correspond to, e.g., HMD device 102 of FIG. 1. For example, user equipment 600 may be a smartphone device, a tablet, a near-eye display device (e.g., HMD), an XR device, or any other suitable device capable of participating in an XR environment, e.g., locally or over a communication network. In another example, user equipment 601 may be a user television equipment system or device. User equipment 601 may include set-top box 615. Set-top box 615 may be communicatively connected to microphone 616, audio output equipment 614 (e.g., speaker, headphones, or the like), and display 612. In some embodiments, microphone 616 may receive audio corresponding to a voice of a user and/or ambient audio data. In some embodiments, display 612 may be a television display, HMD, or a computer display. In some embodiments, set-top box 615 may be communicatively connected to user input interface 610. In some embodiments, user input interface 610 may be a remote-control device. Set-top box 615 may include one or more circuit boards. In some embodiments, the circuit boards may include control circuitry, processing circuitry, and storage (e.g., RAM, ROM, hard disk, removable disk, or the like). In some embodiments, the circuit boards may include an input/output (I/O) path. More specific implementations of user equipment are discussed below in connection with FIG. 7. In some embodiments, user equipment 600 may comprise any suitable number of sensors (e.g., gyroscope or gyrometer, or accelerometer, or the like), and/or a GPS module (e.g., in communication with one or more servers and/or cell towers and/or satellites) to ascertain a location of user equipment 600. In some embodiments, user equipment 600 comprises a rechargeable battery that is configured to provide power to the components of the device.

Each one of user equipment 600 and user equipment 601 may receive content and data via I/O path 602. I/O path 602 (e.g., I/O circuitry for handling input and output signals) may provide content (e.g., broadcast programming, on-demand programming, internet content, content available over a local area network (LAN) or wide area network (WAN), and/or other content) and data to control circuitry 604, which may comprise processing circuitry 606 and storage 608. Control circuitry 604 may be used to send and receive commands, requests, and other suitable data using I/O path 602, which may comprise I/O circuitry. I/O path 602 may connect control circuitry 604 to one or more communications paths (described below). I/O functions may be provided by one or more of these communications paths but are shown as a single path in FIG. 6 to avoid overcomplicating the drawing. While set-top box 615 is shown in FIG. 6 for illustration, any suitable computing device having processing circuitry, control circuitry, and storage may be used in accordance with the present disclosure. For example, set-top box 615 may be replaced by, or complemented by, a personal computer (e.g., a notebook, a laptop, a desktop), a smartphone (e.g., user equipment 600), an XR device, a tablet, a network-based server hosting a user-accessible client device, a non-user-owned device, any other suitable device, or any combination thereof.

Control circuitry 604 may be based on any suitable control circuitry such as processing circuitry 606. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), or the like, and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 604 executes instructions for the system (as described in connection with FIGS. 1-4 and 8) stored in memory (e.g., storage 608). Specifically, control circuitry 604 may be instructed by the system to perform the functions discussed above and below. In some implementations, processing or actions performed by control circuitry 604 may be based on instructions received from the system.

In client/server-based embodiments, control circuitry 604 may include communications circuitry suitable for communicating with a server or other networks or servers. The system may be a stand-alone application implemented on a device or a server. The application may be implemented as software or a set of executable instructions. The application may be the XR application described in FIG. 1. The instructions for performing any of the embodiments discussed herein of the application may be encoded on non-transitory computer-readable media (e.g., a hard drive, random-access memory (RAM) on a dynamic RAM (DRAM) integrated circuit, read-only memory (ROM) on a BLU-RAY disk (BD), or the like). For example, in FIG. 6, the instructions may be stored in storage 608, and executed by control circuitry 604 of a user equipment 600.

In some embodiments, the application may be a client/server application where only the client application resides on user equipment 600, and a server application resides on an external server (e.g., server 704 and/or media content source 702). For example, the application may be implemented partially as a client application on control circuitry 604 of user equipment 600 and partially on server 704 as a server application running on control circuitry 711. Server 704 may be a part of a local area network with one or more of user equipment 600, 601 or may be part of a cloud computing environment accessed via the internet. In a cloud computing environment, various types of computing services for performing searches on the internet or informational databases, providing video communication capabilities, providing storage (e.g., for a database) or parsing data are provided by a collection of network-accessible computing and storage resources (e.g., server 704 and/or an edge computing device), referred to as “the cloud.” User equipment 600 may be a cloud client that relies on the cloud computing capabilities from server 704 to generate personalized engagement options in a VR or AR environment.

Control circuitry 604 may include communications circuitry suitable for communicating with a server, edge computing systems and devices, a table or database server, or other networks or servers. The instructions for carrying out the above-mentioned functionality may be stored on a server (which is described in more detail in connection with FIG. 7). Communications circuitry may include a cable modem, an integrated services digital network (ISDN) modem, a digital subscriber line (DSL) modem, a telephone modem, an Ethernet card, or a wireless modem for communications with other equipment, or any other suitable communications circuitry. Such communications may involve the internet or any other suitable communication networks or paths (which is described in more detail in connection with FIG. 7). In addition, communications circuitry may include circuitry that enables peer-to-peer communication of user equipment, or communication of user equipment in locations remote from each other (described in more detail below).

Memory may be an electronic storage device provided as storage 608 that is part of control circuitry 604. As referred to herein, the phrase “electronic storage device” or “storage device” should be understood to mean any device for storing electronic data, computer software, or firmware, such as RAM, ROM, hard drives, optical drives, digital video disc (DVD) recorders, compact disc (CD) recorders, BD recorders, BD 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Storage 608 may be used to store various types of content described herein as well as application data described above. Nonvolatile memory may also be used (e.g., to launch a boot-up routine and other instructions). Cloud-based storage, described in relation to FIG. 6, may be used to supplement storage 608 or instead of storage 608. Non-transitory memory may store instructions that, when executed by control circuitry, I/O circuitry, any other suitable circuitry or combination thereof, executes functions of an application as described above.

Control circuitry 604 may include video generating circuitry and tuning circuitry, such as one or more analog tuners, one or more Moving Picture Experts Group (MPEG)-2 decoders or High Efficiency Video Coding (HEVC) decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 604 may also include scaler circuitry for upconverting and downconverting content into the preferred output format of user equipment 600. Control circuitry 604 may also include digital-to-analog converter circuitry and analog-to-digital converter circuitry for converting between digital and analog signals. The tuning and encoding circuitry may be used by user equipment 600, 601 to receive and to display, to play, or to record content. The tuning and encoding circuitry may also be used to receive video communication session data. The circuitry described herein, including, for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, or the like). If storage 608 is provided as a separate device from user equipment 600, the tuning and encoding circuitry (including multiple tuners) may be associated with storage 608.

Control circuitry 604 may receive instruction from a user by way of user input interface 610. User input interface 610 may be any suitable user interface, such as a remote control, mouse, trackball, keypad, keyboard, touch screen, touchpad, stylus input, joystick, voice recognition interface, sensor interface (e.g., to track body movement, eye gaze, biometric parameters, or the like), or other user input interfaces. Display 612 may be provided as a stand-alone device or integrated with other elements of each one of user equipment 600 and user equipment 601. For example, display 612 may be a touchscreen or touch-sensitive display. In such circumstances, user input interface 610 may be integrated with or combined with display 612. In some embodiments, user input interface 610 includes a remote-control device having one or more microphones, buttons, keypads, touchscreens, sensors, or any other components configured to receive user input or combinations thereof. For example, user input interface 610 may include a handheld remote-control device having an alphanumeric keypad and option buttons. In a further example, user input interface 610 may include a handheld remote-control device having a microphone and control circuitry configured to receive and identify voice commands and transmit information to set-top box 615.

Audio output equipment 614 may be integrated with or combined with display 612.

Display 612 may be one or more of a monitor, television, transparent display, LCD for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 612. Audio output equipment 614 may be provided as integrated with other elements of each one of user equipment 600 and user equipment 601 or may be stand-alone units. An audio component of videos and other content displayed on display 612 may be played through speakers (or headphones) of audio output equipment 614. In some embodiments, audio may be distributed to a receiver (not shown), which processes and outputs the audio via speakers of audio output equipment 614. In some embodiments, for example, control circuitry 604 is configured to provide audio cues to a user, or other audio feedback to a user, using speakers of audio output equipment 614. There may be a separate microphone 616, or audio output equipment 614 may include a microphone configured to receive audio input such as voice commands or speech. For example, a user may speak letters or words that are received by the microphone and converted to text by control circuitry 604. In a further example, a user may speak voice commands that are received by a microphone and recognized by control circuitry 604. Camera 618 may be any suitable video camera integrated with the equipment or externally connected. Camera 618 may be a digital camera comprising a charge-coupled device (CCD) and/or a complementary metal-oxide semiconductor (CMOS) image sensor. Camera 618 may be an analog camera that converts to digital images via a video card. Camera 618 may be a transparent image sensor. For example, an OST device may use a transparent image sensor to capture a user's gestures, track a user's eye movements, or capture a user's facial expressions in relation to the VR or AR environment that are received by a transparent image sensor (or detector) and recognized by control circuitry 604.

In some embodiments, user equipment 601 may include biometric sensors, environmental sensors, motion sensors, depth sensors, gyroscopes, accelerometers, magnetometers, or any other suitable sensor or combination of such sensors (not shown). For example, an OST device may use a biometric sensor to capture a user's heart rate, speech pattern, galvanic skin response, brain waves, body posture, or the like, in relation to the VR or AR environment that are received by a biometric sensor and recognized by control circuitry 604. For example, an OST device may use an environmental sensor to capture ambient noise, ambient temperature, ambient light (including at least, visible and infrared light), proximate objects, or the like, in relation to the VR or AR environment that are received by an environmental sensor and recognized by control circuitry 604. For example, an OST device may use motion sensors, depth sensors, gyroscopes, accelerometers, and/or magnetometers to capture a user's movements, to track relationship aspects (such as direction, distance, or the like) within their actual environment, or the like, in relation to the VR or AR environment that are received by a motion sensor, depth sensor, gyroscope, accelerometer, and/or magnetometer and recognized by control circuitry 604.

The application may be implemented using any suitable architecture. For example, it may be a stand-alone application wholly implemented on each one of user equipment 600 and user equipment 601. In such an embodiment, instructions of the application may be stored locally (e.g., in storage 608), and data for use by the application is downloaded on a periodic basis (e.g., from an out-of-band feed, from an internet resource, or using another suitable means for storage). Control circuitry 604 may retrieve instructions of the application from storage 608 and process the instructions to provide video conferencing functionality and generate any of the displays discussed herein. Based on the processed instructions, control circuitry 604 may determine what action to perform when input is received from user input interface 610. For example, movement of a cursor on a display up/down may be indicated by the processed instructions when user input interface 610 indicates that an up/down button was selected. In a further example, user gestures, eye movements, or facial expressions may be indicated by the processed instructions when user input interface 610 indicates that a user interacted with a VR or AR object. In a further example, user's biometrics, user's movements, environmental inputs, or the like, may be indicated by the processed instructions when user input interface 610 indicates that a user interacted with a VR or AR object. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, Universal Serial Bus (USB) drive, DVD, CD, media card, register memory, processor cache, RAM, or the like.

Control circuitry 604 may allow a user to provide user profile information or may automatically compile user profile information. For example, control circuitry 604 may access and monitor network data, video data, audio data, processing data, content consumption data, and/or any other suitable data being accessed by a first user (e.g., user 108 wearing a HMD 102). Control circuitry 604 may obtain all or part of other user profiles that are related to a particular user (e.g., via social media networks), and/or obtain information about the user from other sources that control circuitry 604 may access. As a result, a user can be provided with a unified experience across the user's different devices.

In some embodiments, the application is a client/server-based application. Data for use by a thick or thin client implemented on each one of user equipment 600 and user equipment 601 may be retrieved on demand by issuing requests to a server remote from each one of user equipment 600 and user equipment 601. For example, the remote server may store the instructions for the application in a storage device. The remote server may process the stored instructions using circuitry (e.g., control circuitry 604) and generate the displays discussed above and below. The client device may receive the displays generated by the remote server and may display the content of the displays locally on user equipment 600. This way, the processing of the instructions is performed remotely by the server while the resulting displays (e.g., that may include text, a keyboard, or other visuals) are provided locally on user equipment 600. User equipment 600 may receive inputs from the user via user input interface 610 and transmit those inputs to the remote server for processing and generating the corresponding displays. For example, user equipment 600 may transmit a communication to the remote server indicating that an up/down button was selected via user input interface 610. In a further example, user equipment 600 may transmit a communication to the remote server indicating that a user interacted with a VR or AR object via user input interface 610. The remote server may process instructions in accordance with that input and generate a display of the application corresponding to the input (e.g., a display that moves a cursor up/down). The generated display is then transmitted to user equipment 600 for presentation to the user.

In some embodiments, the application may be downloaded and interpreted or otherwise run by an interpreter or virtual machine (run by control circuitry 604). In some embodiments, the application may be encoded in the Enhanced TV (ETV) Binary Interchange Format (EBIF), received by control circuitry 604 as part of a suitable feed, and interpreted by a user agent running on control circuitry 604. For example, the application may be an EBIF application. In some embodiments, the application may be defined by a series of Java-based files that are received and run by a local virtual machine or other suitable middleware executed by control circuitry 604. In some of such embodiments (e.g., those employing MPEG-2, MPEG-4, HEVC or any other suitable digital media encoding schemes), the application may be, for example, encoded and transmitted in an MPEG-2 object carousel with the MPEG audio and video packets of a program.

As shown in FIG. 7, user equipment 706, 707, 708, 710 (which may correspond to user equipment, e.g., HMD device 102 of FIG. 1) may be coupled to communication network 709. Communication network 709 may be one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 709) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 7 to avoid overcomplicating the drawing.

Although communications paths are not drawn between user equipment, these devices may communicate directly with each other via communications paths as well as other short-range, point-to-point communications paths, such as USB cables, Institute of Electrical and Electronics Engineers (IEEE) 1394 cables, wireless paths (e.g., Bluetooth, infrared, IEEE 702-11x, or the like), or other short-range communication via wired or wireless paths. The user equipment may also communicate with each other directly through an indirect path via communication network 709.

System 700 may comprise media content source 702, one or more servers 704, and/or one or more edge computing devices. In some embodiments, the application may be executed at one or more of control circuitry 711 of server 704 (and/or control circuitry of user equipment 706, 707, 708, 710 and/or control circuitry of one or more edge computing devices). The application may be the XR application described in FIG. 1. In some embodiments, the media content source and/or server 704 may be configured to host or otherwise facilitate video communication sessions between user equipment 706, 707, 708, 710 and/or any other suitable user equipment, and/or host or otherwise be in communication (e.g., over communication network 709) with one or more social network services.

In some embodiments, server 704 may include control circuitry 711 and storage 714 (e.g., RAM, ROM, hard disk, removable disk, or the like). Storage 714 may store one or more databases. Server 704 may also include an I/O path 712. In some embodiments, I/O path 712 is an I/O circuitry. I/O circuitry may be a Network Interface Card (NIC) card, audio output device, mouse, keyboard card, any other suitable I/O circuitry device or combination thereof. I/O path 712 may provide video conferencing data, device information, or other data, over a local area network (LAN) or wide area network (WAN), and/or other content and data to control circuitry 711, which may include processing circuitry, and storage 714. Control circuitry 711 may be used to send and receive commands, requests, and other suitable data using I/O path 712, which may comprise I/O circuitry. I/O path 712 may connect control circuitry 711 to one or more communications paths.

Control circuitry 711 may be based on any suitable control circuitry such as one or more microprocessors, microcontrollers, digital signal processors, programmable logic devices, field-programmable gate arrays (FPGAs), application-specific integrated circuits (ASICs), or the like, and may include a multi-core processor (e.g., dual-core, quad-core, hexa-core, or any suitable number of cores) or supercomputer. In some embodiments, control circuitry 711 may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 711 executes instructions for an emulation system application stored in memory (e.g., the storage 714). Memory may be an electronic storage device provided as storage 714 that is part of control circuitry 711. Memory may store instruction to run the application.

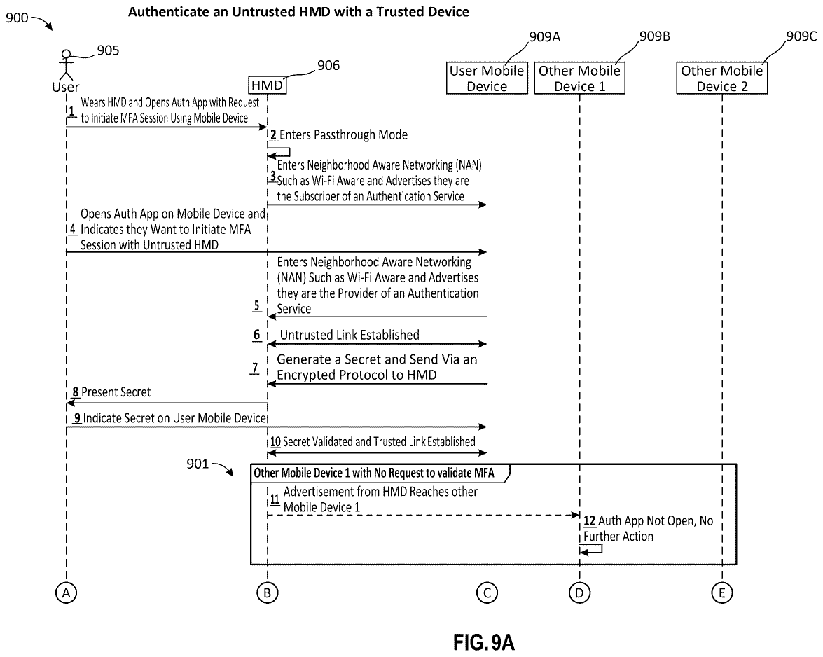

FIG. 8 illustrates a method 800 using a process flowchart for MFA. The method 800 may include a user 805 associated with a user profile, an HMD 806, a mobile device 809 (e.g., trusted mobile phone) and an authentication server 811. A method and system are provided for simplified MFA for users wearing an HMD. This method involves interactions between the HMD 806, a mobile phone 809, and an authentication server 811 to securely authenticate the user 805 (e.g., user profile).

In one embodiment, the method 800 is performed by an HMD 806. The process begins, at step 81, with the user initiating the login process by sending an authentication request for a service. At step 82, the HMD sends an MFA request to an authentication server 811 (e.g., remote server, cloud server, or the like). At step 83, the HMD 806 generates and displays an ROI (e.g., a bounding box) on its screen. At step 84, the MFA request prompts the authentication server 811 to send a verification code (e.g., via SMS) to the user's mobile phone.

At step 85, the user 805 checks the code (e.g., SMS) on the mobile phone 809, which at step 86 is then displayed on the mobile phone 809. At step 87, the user may align the verification code within or adjacent to the ROI (e.g., a bounding box) displayed on the HMD 806. At step 88, the HMD 806 may use optical character recognition (OCR) to recognize the verification code (e.g., QR code, text string, or any suitable code). At step 89, the HMD 806 sends the recognized code to the authentication server 811. At step 90, the authentication server 811 verifies the received code and, upon successful verification, at step 91, grants access to the system's service.

In another embodiment, the method 801 is modified to use a QR code instead of a verification code. At step 92, the authentication server 811 sends a QR code (e.g., via SMS) to the user's mobile phone 809. At step 93, the user checks the mobile phone 809 for the QR code, which is displayed on the mobile phone 809. At steps 94-95, the user shows the QR code within or adjacent to the bounding box displayed on the HMD. At step 96, the HMD 807 uses OCR to recognize the QR code and at step 97, sends the recognized QR code to the authentication server 811. At steps 98-99 the authentication server 811 verifies the received QR code.

In another embodiment, the method 800 is performed from the perspective of the mobile phone 809. The process begins with the user 805 logging in for authentication (e.g., step 81), and the HMD 806 sending an MFA request to the authentication server 811 while presenting an ROI (e.g., a bounding box). The authentication server 811 sends a verification code via SMS to the mobile phone 809. The user 805 checks the SMS for the verification code, which is then displayed on the mobile phone 809. The HMD 806 recognizes the code using OCR, sends the verification code to the authentication server 811, which then verifies the code and grants access.

In this embodiment, the method 801 can also be modified to use a QR code instead of a verification code. The authentication server 811 sends a QR code (e.g., step 92) via SMS to the user's mobile phone 908. The user 805 checks the SMS for the QR code, which is then displayed on the mobile phone 809. The HMD 806 recognizes the QR code using OCR, sends the QR code to the authentication server 811, which then verifies the QR code.

In another embodiment, the method 800 is performed from the perspective of the authentication server 811. The process begins with the user logging in for authentication. The HMD 806 sends an MFA (e.g., step 82) request to the authentication server 811 and presents an ROI (e.g., a bounding box). The authentication server 811 sends a verification code via SMS to the mobile phone 809. The user 805 checks the SMS for the verification code, displays it to the HMD 806, which recognizes and sends the code to the authentication server 811. The server then verifies the code and grants access.

In another embodiment, methods 800 and 801 describe a fully automatic solution that requires minimal interaction from the user 805. In this method, the HMD 806 utilizes an inward-facing camera to capture eye area information of the user 805. Upon a request for MFA, the camera captures 3D eye area data, which is then used to verify the user's identity against facial data stored on the user's mobile device 809.

In this embodiment, when the user 805 attempts to log into their account on the HMD 806, the authentication system recognizes that the user is accessing the account through an untrusted HMD browser. The system may detect that the user has a corresponding authentication application installed on their mobile device 809 (i.e., an authenticated mobile device). The HMD 806 collects the biometric information, processes it, and sends it to the authentication app on the mobile device 809. This transmission can be accomplished, for example, through a mobile notification.

In some embodiments, if the biometric data matches, the mobile device 809 sends verification information directly back to the application or webpage on the HMD 806 to authenticate the user's access. While this partial biometric match may not be as robust as full facial recognition systems, it enhances security without requiring any additional manual steps from the user. Therefore, compared to single-factor authentication (1FA) that many users still rely on—even for sensitive accounts like banking—this method provides added value.

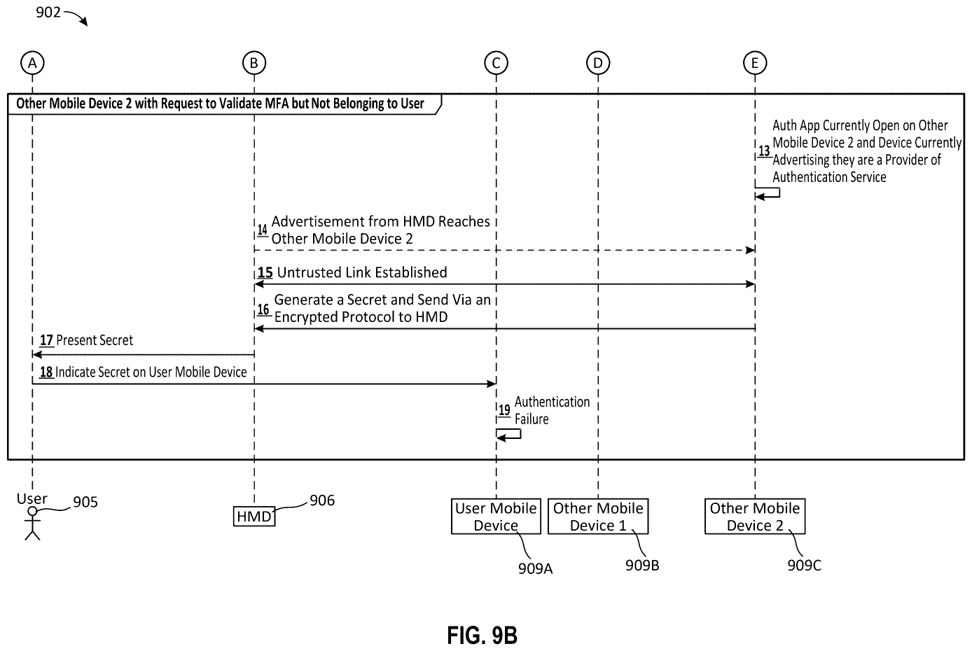

FIG. 9A illustrates a method 900 using a process flowchart for MFA. The method 900 may include a user 905 associated with a user profile, an HMD 906, a first mobile device 909A (e.g., a user mobile device), a second mobile device 909B, and a third mobile device 909C. A method and system 900 are provided for MFA from the perspective of an HMD. Specifically, discussing authenticating an untrusted HMD with a trusted device.

In one embodiment, at step 1, the process begins with the user 905 wearing the HMD 906 and opening an authentication application on their mobile device (e.g., a first mobile device 909A) to initiate an MFA session. The first mobile device 909A may be a trusted (e.g., pre-authenticated) user mobile device. At step 2, the HMD 906 then, at step 3, enters passthrough mode (e.g., VST, OST, or the like) and engages in NAN (e.g., Wi-Fi Aware) to advertise that it is a subscriber of an authentication service. For example, step 3 may be initiated by a user action received by the HMD, such as opening an authentication app on the HMD. Also, it is noted that step 3 may be omitted in some implementations. At step 4, the user 905 may open the authentication application on their mobile device (e.g., a first mobile device 909A) and indicates their intention to initiate an MFA session with the untrusted HMD 906. At step 5, the mobile device may also enter NAN and advertises that it is the provider of an authentication service. At step 6, the HMD 906 and the mobile device (e.g., a first mobile device 909A) establish an untrusted link. At step 7, the mobile device (e.g., a first mobile device 909A) generates a secret and sends it to the HMD 906 via an encrypted protocol. At step 8, the HMD 906 presents the secret to the user 905, who then indicates, at step 9, the secret on their mobile device (e.g., a first mobile device 909A). At step 10, the HMD 906 and the mobile device (e.g., a first mobile device 909A) share a validated secret and establish a trusted link.

Regarding the term “secret,” for example, in the context of authentication of users and user devices, secret refers to any confidential information used to verify the identity of a user or device during the authentication process. This secret can take various forms, such as passwords, personal identification numbers (PINs), cryptographic keys, or other sensitive data that must be protected from unauthorized access. The primary function of a secret is to serve as a piece of information that only the legitimate user or device should know, thereby enabling the system to validate their identity. Also, for example, during the authentication process, the user or device presents the secret to the system, which then compares it against a stored value to determine its validity. This comparison is typically done using secure methods to prevent interception or tampering. Further, for example, passwords are often hashed and stored in a database, and during authentication, the entered password is hashed and compared to the stored hash. If the hashes match, the user is authenticated. In addition, for example, the security of the authentication process relies on the secrecy and complexity of the secret. Simple or easily guessable secrets can be compromised through various attacks, such as brute force or social engineering. Therefore, best practices in authentication include using strong, unique secrets and implementing additional security measures, such as MFA, to enhance protection. In technical literature, secrets are often discussed in the context of their management and protection. Effective secrets management involves securely generating, storing, and transmitting secrets, as well as regularly updating them to mitigate the risk of compromise. This includes using cryptographic techniques to protect secrets in transit and at rest, and employing access controls to ensure that only authorized entities can access or use the secrets

In another embodiment, the method 901, at step 11, begins with the HMD 906 transmitting an advertisement by an HMD requesting authentication from an authentication provider user mobile device (e.g., a second mobile device 909B referred to as other mobile device 1). At step 12, if the authentication application is not open on the other mobile device 1, no further action is taken.

In a different scenario, at step 13, if another mobile device (e.g., a third mobile device 909C) has its authentication application open and is advertising as a provider of an authentication service, then at step 14, the HMD 906 transmits an advertisement that reaches the third mobile device 909C.

At step 15, the HMD 906 and third mobile device 909C establish an untrusted link. At step 16, the third mobile device 909C generates a secret and transmits it to the HMD 906 via an encrypted protocol.

At step 17, the HMD 906 presents the secret to the user 905, who indicates, at step 18, the secret on their mobile device (e.g., first mobile device 909A). At step 19, if the user mobile device (e.g., first mobile device 909A) indicates authentication failure (e.g., since the secret was not generated by the user mobile device 909A), the process ends.

From the perspective of the user mobile device (e.g., first mobile device 909A), the method involves the user 905 wearing the HMD 906 and opening the authentication application to initiate the MFA session. The HMD 906 enters passthrough mode and engages in NAN to advertise its subscription to an authentication service. The user opens the authentication application on their mobile device (e.g., first mobile device 909A) and indicates their intention to initiate an MFA session with the untrusted HMD 906. The mobile device (e.g., first mobile device 909A) enters NAN and advertises as the provider of an authentication service. The HMD 906 and the mobile device (e.g., first mobile device 909A) establish an untrusted link. The mobile device (e.g., first mobile device 909A) generates a secret and sends it to the HMD 906 via an encrypted protocol. The HMD 906 presents the secret to the user 905, who indicates the secret on their mobile device (e.g., first mobile device 909A). This allows the HMD 906 and the mobile device (e.g., first mobile device 909A) to share a validated secret and establish a trusted link.

In another embodiment, if other mobile device 2 (e.g., third mobile device 909C) has its authentication application open and is advertising as a provider of an authentication service, the HMD 906 transmits an advertisement that reaches other mobile device 2 (e.g., third mobile device 909C). The HMD 906 and another mobile device 2 (e.g., third mobile device 909C) establish an untrusted link. Another mobile device 2 (e.g., third mobile device 909C) generates a secret and transmits it to the HMD 906 via an encrypted protocol. The HMD 906 presents the secret to the user 905, who indicates the secret on their mobile device (e.g., first mobile device 909A). If the user mobile device (e.g., first mobile device 909A) indicates authentication failure, the process ends.

From the perspective of other mobile device 1 (e.g., second mobile device 909B), the method 902 involves the user 905 wearing the HMD 906 and opening the authentication application to initiate the MFA session. The HMD 906 enters passthrough mode and engages in NAN to advertise its subscription to an authentication service. The user 905 opens the authentication application on their mobile device (e.g., first mobile device 909A) and indicates their intention to initiate an MFA session with the untrusted HMD 906. The mobile device (e.g., first mobile device 909A) enters NAN and advertises as the provider of an authentication service. The HMD 906 and the mobile device (e.g., first mobile device 909A) establish an untrusted link. The mobile device (e.g., first mobile device 909A) generates a secret and sends it to the HMD 906 via an encrypted protocol. The HMD 906 presents the secret to the user 905, who indicates the secret on their mobile device (e.g., first mobile device 909A). This allows the HMD 906 and the mobile device (e.g., first mobile device 909A) to share a validated secret and establish a trusted link. If the HMD 906 transmits an advertisement that reaches other mobile device 1 (e.g., second mobile device 909B) and the authentication application is not open on other mobile device 1 (e.g., second mobile device 909B), no further action is taken.

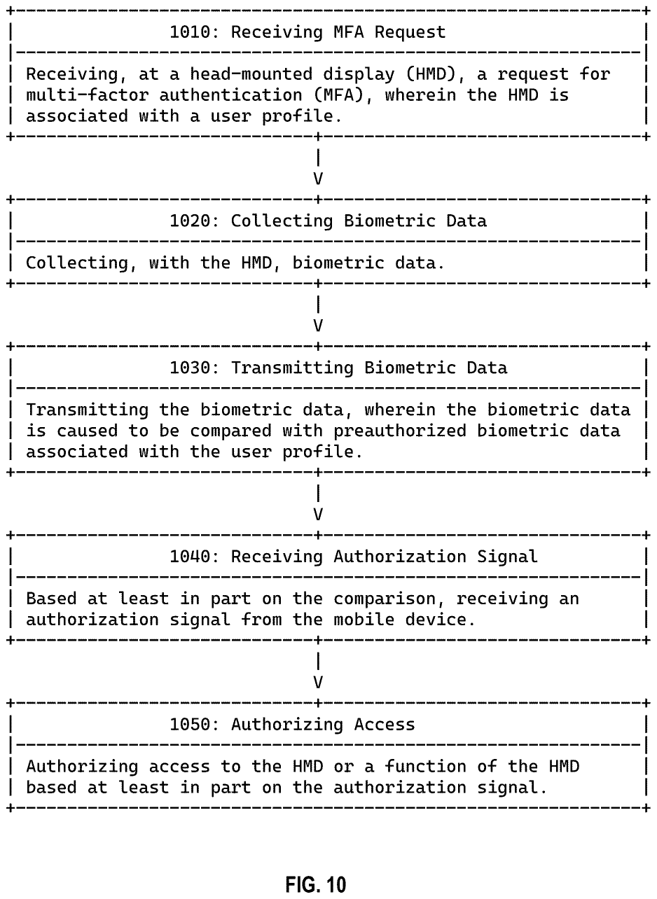

Methods depicted in FIGS. 10-14 each describe different approaches to MFA using an HMD and a mobile device. The method in FIG. 10 involves receiving an MFA request, collecting biometric data, transmitting this data to a mobile device, and authorizing access based on the comparison of the biometric data. The method of FIG. 10 utilizes biometric data, which is generally secure and difficult to forge, ensuring that the authentication is tied to the user's unique biometric identifiers. This method is useful for scenarios requiring high security, such as accessing sensitive information or secure environments.

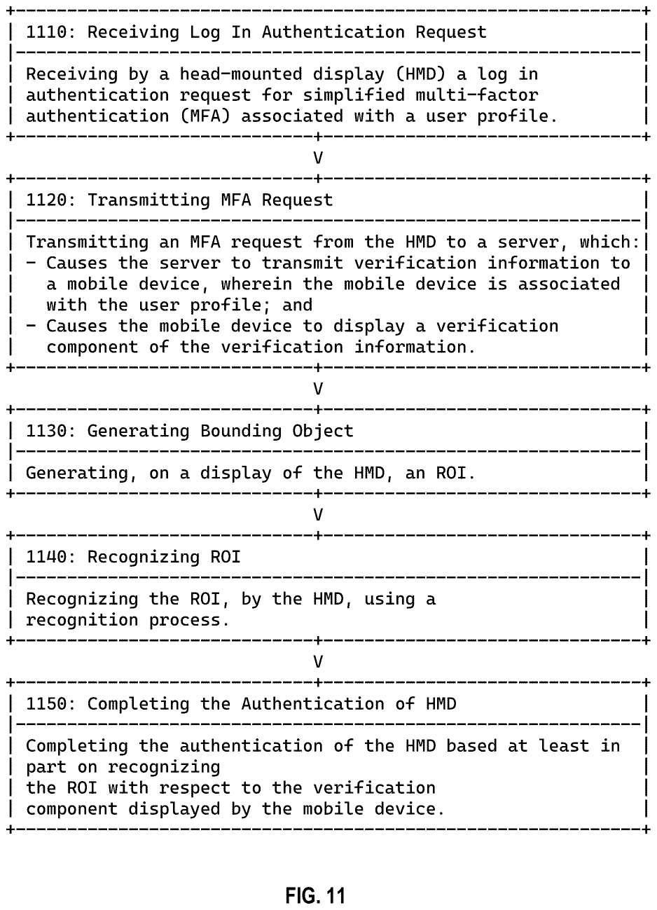

The method in FIG. 11 simplifies MFA by using a bounding object for user interaction. The method of FIG. 11 involves receiving a log in request, transmitting an MFA request, generating and recognizing a bounding object, and authenticating based on this recognition. The method of FIG. 11 simplifies the user interaction process by using visual elements (e.g., bounding objects) for authentication. This method is suitable for applications where ease of use and speed are prioritized, such as consumer electronics.

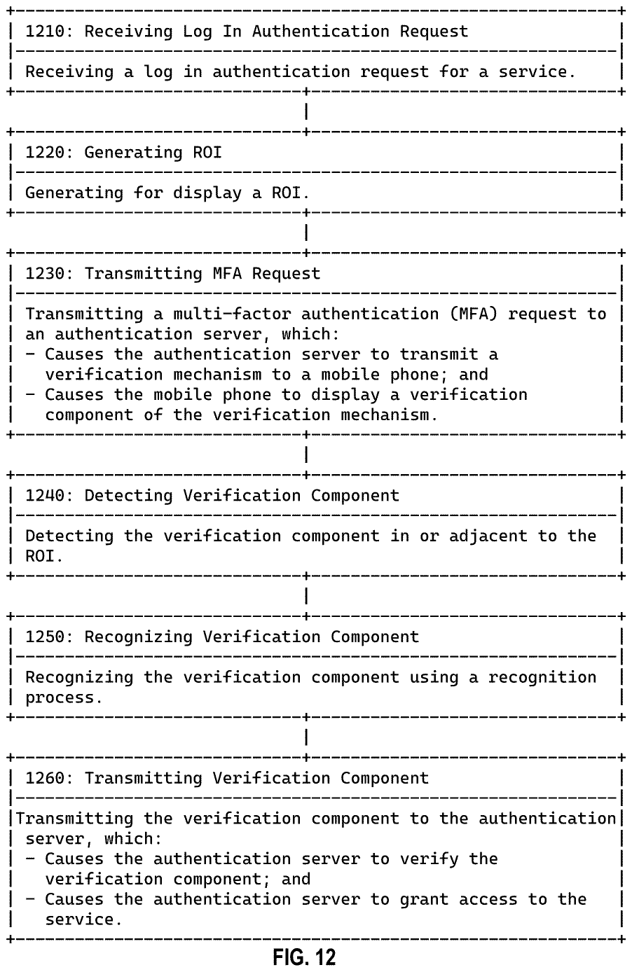

The method in FIG. 12 involves generating a bounding box, transmitting an MFA request, detecting and recognizing a verification component within the bounding box, and verifying the component. The method of FIG. 12 combines visual verification with bounding boxes, adding an extra layer of security by ensuring the verification component is correctly identified. This method is useful in environments where visual verification can be easily implemented, such as AR applications.

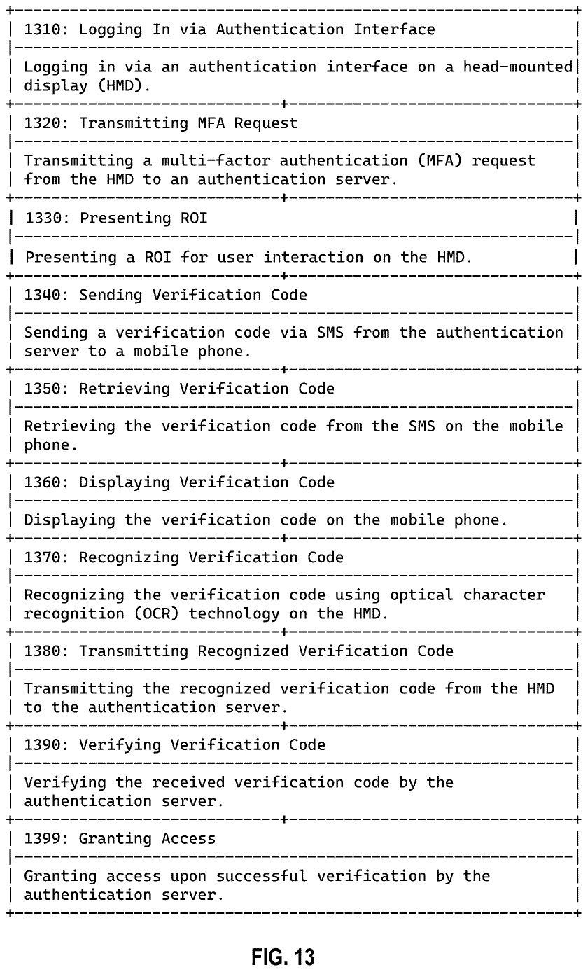

The method in FIG. 13 uses optical character recognition (OCR) to recognize a verification code. The method of FIG. 13 involves logging in, transmitting an MFA request, presenting a bounding box, sending and retrieving a verification code, recognizing the code using OCR, and verifying the code. OCR technology is provided to automate the recognition of verification codes, reducing the potential for human error. This method is useful in scenarios where verification codes are used frequently, such as online banking or secure logins.

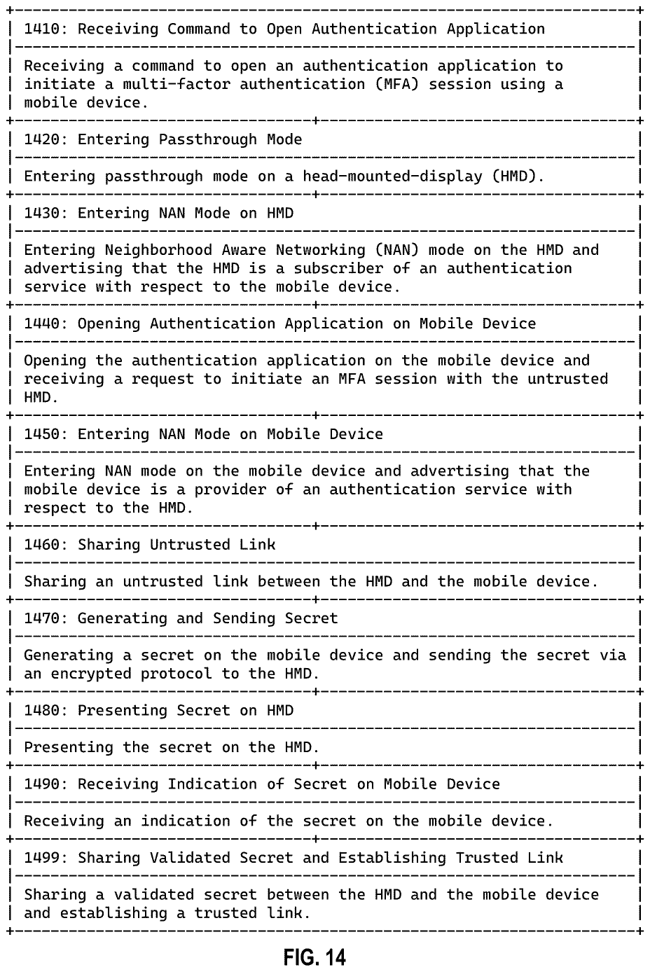

The method in FIG. 14 involves using NAN mode and secret sharing. The method of FIG. 14 includes opening an authentication application, entering passthrough and NAN modes, sharing an untrusted link, generating and sending a secret, presenting and receiving an indication of the secret, and establishing a trusted link. The method of FIG. 14 establishes a secure communication channel through secret sharing and NAN mode, ensuring that the link between devices is trusted. This method is useful for establishing secure connections in environments with multiple devices, such as smart homes or IoT networks.

The methods of FIGS. 10-14 provide secure authentication. The biometric data method of FIG. 10 offers high security due to the uniqueness of biometric identifiers. FIG. 11 and FIG. 12 focus on simplifying user interaction through visual elements. FIG. 13 includes OCR technology, which is beneficial for automating the recognition process. FIG. 14 uses NAN mode and secret sharing, emphasizing secure communication between devices.

FIG. 10 and FIG. 14 involve biometrics and NAN mode, while FIG. 11 and FIG. 12 offer simpler, more intuitive user interactions. FIG. 10 and FIG. 13 require specific hardware capabilities (e.g., biometric sensors and OCR technology), whereas FIG. 11 and FIG. 12 can be implemented with standard visual display technologies.

In some embodiments, a method for MFA using an HMD is provided. As illustrated in FIG. 10, the method begins with step 1010, which involves receiving, at the HMD, a request for multi-factor authentication. The HMD is associated with a user profile that contains preauthorized biometric data. For example, the user profile may include facial identification data, e.g., facial recognition data, iris scan data, or the like. This step ensures that the authentication process is initiated securely and is linked to the correct user profile.

In step 1020, the HMD collects biometric data from the user. This biometric data can include various types of identifiers such as facial features or iris patterns. The collection of biometric data is crucial for verifying the identity of the user. For instance, the HMD may use its built-in camera to capture an image of the user's face and extract biometric features from the image.

In step 1030, the collected biometric data is transmitted from the HMD to a mobile device associated with the user profile. The mobile device is responsible for comparing the transmitted biometric data with the preauthorized biometric data stored in the user profile. This comparison is essential for verifying the authenticity of the biometric data. For example, the mobile device may use a secure application to perform the comparison and determine if the biometric data matches.

Based on the comparison of the biometric data, the mobile device sends an authorization signal back to the HMD in step 1040. This signal indicates whether the biometric data matches the preauthorized data, thereby confirming the user's identity. If the biometric data is verified successfully, the HMD authorizes access in step 1050. This step completes the MFA process, ensuring secure access to the HMD.

In another embodiment, as shown in FIG. 11, a method involves step 1110, where the HMD receives a log in authentication request for simplified multi-factor authentication associated with a user profile. In step 1120, the HMD transmits an MFA request to a server, which then transmits verification information to a mobile device associated with the user profile. The mobile device displays a verification component of the verification information. In step 1130, the HMD generates an ROI (e.g., a bounding object) on its display, which is used for user interaction and verification purposes. The HMD recognizes the ROI using a recognition process in step 1140, ensuring that the ROI is correctly identified for the authentication process. The HMD is authenticated based on recognizing the ROI with respect to the verification component displayed by the mobile device, completing the simplified MFA process and granting access to the HMD in step 1150.

Another method, depicted in FIG. 12, involves step 1210, where a log in authentication request for a service is received. In step 1220, a bounding box is generated for display. An MFA request is transmitted to an authentication server in step 1230. The server transmits a verification mechanism to a mobile phone and causes the mobile phone to display a verification component of the verification mechanism. In step 1240, the verification component is detected in or adjacent to the bounding box. The verification component is recognized using a recognition process in step 1250. The recognized verification component is transmitted to the authentication server in step 1260. The server verifies the component and grants access to the service. This method ensures secure access to the service through a multi-step verification process.

In yet another embodiment, as illustrated in FIG. 13, a method starts with step 1310, logging in via an authentication interface on a head-mounted display. In step 1320, an MFA request is transmitted from the HMD to an authentication server. In step 1330, a bounding box is presented for user interaction on the HMD. A verification code is sent via SMS from the authentication server to a mobile phone in step 1340. The verification code is retrieved from the SMS on the mobile phone in step 1350 and displayed on the mobile phone in step 1360. The verification code is recognized using optical character recognition (OCR) technology on the HMD in step 1370. The recognized verification code is transmitted from the HMD to the authentication server in step 1380. The authentication server verifies the received verification code in step 1390. Access is granted upon successful verification by the authentication server in step 1399, completing the MFA process.

Another method, shown in FIG. 14, involves step 1410, where a command to open an authentication application to initiate a multi-factor authentication session using a mobile device is received. In step 1420, the HMD enters passthrough mode. The HMD then enters NAN mode in step 1430, advertising that it is a subscriber of an authentication service with respect to the mobile device. In step 1440, the authentication application is opened on the mobile device, and a request to initiate an MF A session with the untrusted HMD is received. The mobile device enters NAN mode in step 1450 and advertises that it is a provider of an authentication service with respect to the HMD. An untrusted link is shared between the HMD and the mobile device in step 1460. In step 1470, a secret is generated on the mobile device and sent via an encrypted protocol to the HMD. The secret is presented on the HMD in step 1480 and indicated (e.g., by the user via user input received from the user at the HMD) on the mobile device in step 1490. A validated secret is shared between the HMD and the mobile device in step 1499, establishing a trusted link. This method ensures secure communication and access through a series of steps involving secret generation and validation.

The terminology used herein is for the purpose of describing particular embodiments only and is not intended to be limiting of the disclosure.

Throughout the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises.”

Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

As used herein, the terms “real time,” “simultaneous,” “substantially on-demand,” and the like are understood to be nearly instantaneous but may include delay due to practical limits of the system. Such delays may be in the order of milliseconds or microseconds, depending on the application and nature of the processing. Relatively longer delays (e.g., greater than a millisecond) may result due to communication or processing delays, particularly in remote and cloud-computing environments.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although at least some embodiments are described as using a plurality of units or modules to perform a process or processes, it is understood that the process or processes may also be performed by one or a plurality of units or modules. Additionally, it is understood that the term controller/control unit may refer to a hardware device that includes a memory and a processor. The memory may be configured to store the units or the modules, and the processor may be specifically configured to execute said units or modules to perform one or more processes which are described herein.

Unless specifically stated or obvious from context, as used herein, the term “about” is understood as within a range of normal tolerance in the art, for example within 2 standard deviations of the mean. “About” may be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The use of the terms “first”, “second”, “third”, and so on, herein, are provided to identify structures or operations, without describing an order of structures or operations, and, to the extent the structures or operations are used in an embodiment, the structures may be provided or the operations may be executed in a different order from the stated order unless a specific order is definitely specified in the context.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory (e.g., a non-transitory, computer-readable medium accessible by an application via control or processing circuitry from storage) including, but not limited to, volatile and non-volatile computer memory or storage devices such as a hard disk, floppy disk, USB drive, DVD, CD, media cards, register memory, processor caches, RAM, UltraRAM, cloud-based storage, and the like.

The interfaces, processes, and analysis described may, in some embodiments, be performed by an application. The application may be loaded directly onto each device of any of the systems described or may be stored in a remote server or any memory and processing circuitry accessible to each device in the system. The generation of interfaces and analysis there-behind may be performed at a receiving device, a sending device, or some device or processor therebetween.

Any use of a phrase such as “in some embodiments” or the like with reference to a feature is not intended to link the feature to another feature described using the same or a similar phrase. Any and all embodiments disclosed herein are combinable or separately practiced as appropriate. Absence of the phrase “in some embodiments” does not infer that the feature is necessary. Inclusion of the phrase “in some embodiments” does not infer that the feature is not applicable to other embodiments or even all embodiments.

The systems and processes discussed herein are intended to be illustrative and not limiting. One skilled in the art would appreciate that the actions of the processes discussed herein may be omitted, modified, combined, duplicated, rearranged, and/or substituted, and any additional actions may be performed without departing from the scope of the invention. More generally, the disclosure herein is meant to provide examples and is not limiting. Only the claims that follow are meant to set bounds as to what the present disclosure includes. Furthermore, it should be noted that the features and limitations described in any some embodiments may be applied to any other embodiment herein, and flowcharts or examples relating to some embodiments may be combined with any other embodiment in a suitable manner, done in different orders, or done in parallel. In addition, the methods and systems described herein may be performed in real time. It should also be noted that the methods and/or systems described herein may be applied to, or used in accordance with, other methods and/or systems.

This description is to be taken only by way of example and not to otherwise limit the scope of the embodiments herein. Therefore, it is the object of the appended claims to cover all such variations and modifications as come within the true spirit and scope of the embodiments herein.

1. A method comprising:
receiving, at a head-mounted-display (HMD), a request for multi-factor authentication (MFA), wherein the HMD is associated with a user profile;
collecting, with the HMD, biometric data;
transmitting the biometric data, wherein the biometric data is caused to be compared with preauthorized biometric data associated with the user profile;
based at least in part on the comparison, receiving an authorization signal; and
authorizing access to the HMD or a function of the HMD based at least in part on the authorization signal.

2. The method of claim 1, wherein the biometric data comprises 3D information from an inward-facing imaging system.

3. The method of claim 2, comprising:
generating a biometric signature based at least in part on the 3D information from the inward-facing imaging system.

4. The method of claim 3, wherein the comparison comprises comparing the biometric signature based at least in part on the 3D information from the inward-facing imaging system to at least a portion of facial identification data stored on a mobile device, wherein the method comprises:
determining a similarity score based at least in part on the comparison;
determining that the similarity score satisfies a predetermined condition; and
the authorizing the access to the HMD or the function of the HMD based at least in part on the authorization signal is further based at least in part on the similarity score satisfying the predetermined condition.

5. The method of claim 3, wherein the collection of the 3D information from the inward-facing imaging system comprises:
scanning at least a portion of a facial area using the inward-facing imaging system of the HMD to capture 3D eye data; and
generating the biometric signature based at least in part on the captured 3D eye data.

6. The method of claim 3, wherein the collection of the 3D information from the inward-facing imaging system comprises:
scanning at least a portion of a facial area using the inward-facing imaging system of the HMD to capture partial facial data; and
generating the biometric signature based at least in part on the captured partial facial data.

7. The method of claim 1, comprising:
generating a dynamic action instruction;
generating for display the dynamic action instruction;
receiving input;
determining that the input corresponds to the dynamic action instruction; and
authorizing access to the HMD or the function of the HMD based at least in part on the authorization signal and the determination that the input corresponds to the dynamic action instruction.

8. The method of claim 7, wherein:
the dynamic action instruction is to tap a virtual icon with a mobile device;
the input is a visual confirmation by the HMD; and
the determining that the input corresponds to the dynamic action instruction corresponds with the virtual icon being tapped with the mobile device.

9. The method of claim 7, wherein:
the dynamic action instruction is to perform a gesture in a virtual space visible to the HMD;
the input is a visual confirmation by the HMD; and
the determining that the input corresponds to the dynamic action instruction corresponds with the gesture being performed in the virtual space visible to the HMD.

10. The method of claim 7, wherein:
the dynamic action instruction is to perform a spatial gesture with a mobile device; the input is a confirmation from the mobile device; and
the determining that the input corresponds to the dynamic action instruction is the confirmation from the mobile device that the spatial gesture was performed with the mobile device.

11-21. (canceled)

21. A system comprising:
control circuitry configured to:
receive, at a head-mounted-display (HMD), a request for multi-factor authentication (MFA), wherein the HMD is associated with a user profile;
collect, with the HMD, biometric data;
transmit the biometric data, wherein the biometric data is caused to be compared with preauthorized biometric data associated with the user profile;
based at least in part on the comparison, receiving an authorization signal; and
authorize access to the HMD or a function of the HMD based at least in part on the authorization signal.

22. The system of claim 21, wherein the biometric data comprises 3D information from an inward-facing imaging system.

23. The system of claim 22, wherein the control circuitry is further configured to:
generate a biometric signature based at least in part on the 3D information from the inward-facing imaging system.

24. The system of claim 23, wherein the control circuitry is further configured to compare the biometric signature based at least in part on the 3D information from the inward-facing imaging system to at least a portion of facial identification data stored on a mobile device by:
determining a similarity score based at least in part on the comparison;
determining that the similarity score satisfies a predetermined condition; and
the authorizing the access to the HMD or the function of the HMD based at least in part on the authorization signal is further based at least in part on the similarity score satisfying the predetermined condition.

25. The system of claim 23, wherein the control circuitry is further configured to collect the 3D information from the inward-facing imaging system by:
scanning at least a portion of a facial area using the inward-facing imaging system of the HMD to capture 3D eye data; and
generating the biometric signature based at least in part on the captured 3D eye data.

26. The system of claim 23, wherein the control circuitry is further configured to collect the 3D information from the inward-facing imaging system by:
scanning at least a portion of a facial area using the inward-facing imaging system of the HMD to capture partial facial data; and
generating the biometric signature based at least in part on the captured partial facial data.

27. The system of claim 21, wherein the control circuitry is further configured to:
generate a dynamic action instruction;
generate for display the dynamic action instruction;
receive input;
determine that the input corresponds to the dynamic action instruction; and
authorize access to the HMD or the function of the HMD based at least in part on the authorization signal and the determination that the input corresponds to the dynamic action instruction.

28. The system of claim 27, wherein:
the dynamic action instruction is to tap a virtual icon with a mobile device;
the input is a visual confirmation by the HMD; and
the determining that the input corresponds to the dynamic action instruction corresponds with the virtual icon being tapped with the mobile device.

29. The system of claim 27, wherein:
the dynamic action instruction is to perform a gesture in a virtual space visible to the HMD;
the input is a visual confirmation by the HMD; and
the determining that the input corresponds to the dynamic action instruction corresponds with the gesture being performed in the virtual space visible to the HMD.

30. The system of claim 27, wherein:
the dynamic action instruction is to perform a spatial gesture with a mobile device;
the input is a confirmation from the mobile device; and
the determining that the input corresponds to the dynamic action instruction is the confirmation from the mobile device that the spatial gesture was performed with the mobile device.

31-100. (canceled)
